(19) United States
(12) Patent Application Publication
(10) Pub. No.: US 2013/0236217 A1
(43) Pub. Date: Sep. 12, 2013

(54) DEVELOPMENT DEVICE, AND IMAGE FORMING APPARATUS AND PROCESS UNIT INCORPORATING SAME

(71) Applicants: Yuji NAGATOMO, Osaka (JP); Yasuhide Matsuno, Osaka (JP); Takahiro Sanada, Osaka (JP); Naoki Nakatake, Hyogo (JP); Takafumi Miyazaki, Osaka (JP); Yasuhiro Fujiwara, Osaka (JP); Kyoko Abe, Osaka (JP); Rumi Miyazaki, Osaka (JP); Takeshi Yamashita, Osaka (JP); Tomoya Adachi, Hyogo (JP)

(72) Inventors: Yuji NAGATOMO, Osaka (JP); Yasuhide Matsuno, Osaka (JP); Takahiro Sanada, Osaka (JP); Naoki Nakatake, Hyogo (JP); Takafumi Miyazaki, Osaka (JP); Yasuhiro Fujiwara, Osaka (JP); Kyoko Abe, Osaka (JP); Rumi Miyazaki, Osaka (JP); Takeshi Yamashita, Osaka (JP); Tomoya Adachi, Hyogo (JP)

(21) Appl. No.: 13/795,008

(22) Filed: Mar. 12, 2013

(30) Foreign Application Priority Data
Mar. 12, 2012 (JP) 2012-054771

(51) Int. Cl. G03G 15/08

(52) U.S. Cl. CPC G03G 9/08
USPC 399/281

(57) ABSTRACT

A development device to develop a latent image using developer having a degree of agglomeration of 54% or greater includes a developer bearer to carry developer thereon, and a developer supply member to contact the developer bearer to supply developer to a surface of the developer bearer. The developer supply member is disposed to satisfy at least one of two conditions: a biting amount of the developer supply member relative to the developer bearer is 0.7 mm or greater; and a contact pressure of the developer supply member against the developer bearer is 30 N/m or greater.

### CROSS-REFERENCE TO RELATED APPLICATION

This patent application is based on and claims priority pursuant to 35 U.S.C. §119 to Japanese Patent Application No. 2012-054771, filed on Mar. 12, 2012, in the Japan Patent Office, the entire disclosure of which is hereby incorporated by reference herein.

### BACKGROUND OF THE INVENTION

1. Field of the Invention

The present invention generally relates to a development device and an image forming apparatus, such as a copier, a printer, a facsimile machine, or a multifunction machine including at least two of these functions and a process unit that includes a development device.

2. Description of the Related Art

Electrophotographic image forming apparatuses, such as copiers, printers, facsimile machines, and multifunction machines including multiple capabilities thereof, include a development device to develop latent images formed on a photoreceptor serving as a latent image bearer. Development devices typically include a development roller to carry developer (i.e., toner) on its surface, a supply roller to supply toner to the development roller, and a developer regulator, such as a doctor blade, to regulate the amount of toner on the development roller as disclosed in JP-2001-154480-A, for example.

The supply roller is disposed to contact the development roller, thus forming a contact nip, where toner contained in the development device is charged through triboelectric charging. Then, toner is supplied to the surface of the development roller. The regulation blade adjusts the amount of toner on the development roller uniformly, and electrical charges are given to the toner. In a development range between the photoreceptor and the development roller, toner is transferred to a latent image on the photoreceptor, developing it into a toner image. Thus, toner is transferred from the supply roller to the development roller and further from the development roller to the photoreceptor, thereby forming images on sheets.

It is preferred to reduce wear of components to expand the operational life of the device. For example, the surface of the photoreceptor wears due to contact with a changing device, the development device, a transfer device, and a cleaning device. To reduce the wear, the surface of the photoreceptor is generally lubricated.

Providing a device to lubricate the photoreceptor can be a hindrance to compactness of the apparatus. Therefore, for example, JP-2002-341615-A proposes use of toner including a lubricating component, such as silicone oil, instead of providing a lubrication device.

### SUMMARY OF THE INVENTION

In view of the foregoing, one embodiment of the present invention provides a development device that develops a latent image with developer having a degree of agglomeration of 54% or greater. The development device includes a developer bearer to carry developer thereon, and a developer supply member to contact the developer bearer to supply developer to a surface of the developer bearer. The developer supply member is disposed to satisfy at least one of two conditions: 1) a biting amount of the developer supply member relative to the developer bearer is 0.7 mm or greater; and 2) a contact pressure of the developer supply member against the developer bearer is 30 N/m or greater.

Another embodiment provides a process unit removably mounted in an apparatus body of an image forming apparatus, and the process unit includes a latent image bearer on which a latent image is formed and the above-described development device.

Yet another embodiment provides an image forming apparatus that includes either the above-described development device or the above-described process unit.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of an image forming apparatus according to an embodiment of the present invention;

FIG. 2 is a schematic end-on axial view of a development device and a toner cartridge;

FIG. 3 is an enlarged cross-sectional view of the development device shown in FIG. 2;

FIG. 4 is a side view of a lateral end seal as viewed in a direction perpendicular to an axis of a development roller;

FIG. 5 is an enlarged cross-sectional view of the lateral end seal;

FIG. 6 is a perspective view of a developer amount detector;

FIG. 7 is an end-on axial view illustrating a biting amount of a supply roller relative to the development roller;

FIGS. 8A and 8B show evaluation results regarding image density and the amount of abrasion among configuration according to an embodiment and comparative examples;

FIG. 9 shows evaluation results regarding toner charge amount and the amount of adhering toner among configuration according to an embodiment and comparative examples;

FIG. 10 illustrates a range in which the amount of charge of toner and the amount of toner adhering to the development roller are measured;

FIG. 11 is a side view of a lateral end seal in a comparative configuration;

FIG. 12A is a perspective view of a configuration in which fibers of the lateral end seal lean in a direction following the rotational direction of the development roller and inclined toward the axial center;

FIG. 12B is a side view illustrating the leaning direction shown in FIG. 12A;

FIG. 13 is a cross-sectional view illustrating a biting amount of the lateral end seal relative to the surface of the development roller;

FIG. 14 is a side view illustrating an angle of leaning of fibers of the lateral end seal;

FIGS. 15A and 15B show evaluation results regarding firm adhesion of toner, toner leakage, and the abrasion amount of photoreceptors among configurations according to an embodiment and comparative examples;

FIG. 16 is a cross-sectional view illustrating a biting amount of an entrance seal relative to the surface of the development roller;

FIG. 17 is a schematic diagram illustrating measurement of the biting amount of the entrance seal;

FIG. 18 is a schematic view illustrating a nip width (a length in a circumferential direction of the development roller) between the entrance seal and the development roller; and

FIGS. 19A and 19B are tables showing evaluation results regarding unintended vertical lines in images, toner leakage, and the abrasion amount of photoreceptors among configurations according to an embodiment and comparative examples.

### DETAILED DESCRIPTION OF THE INVENTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

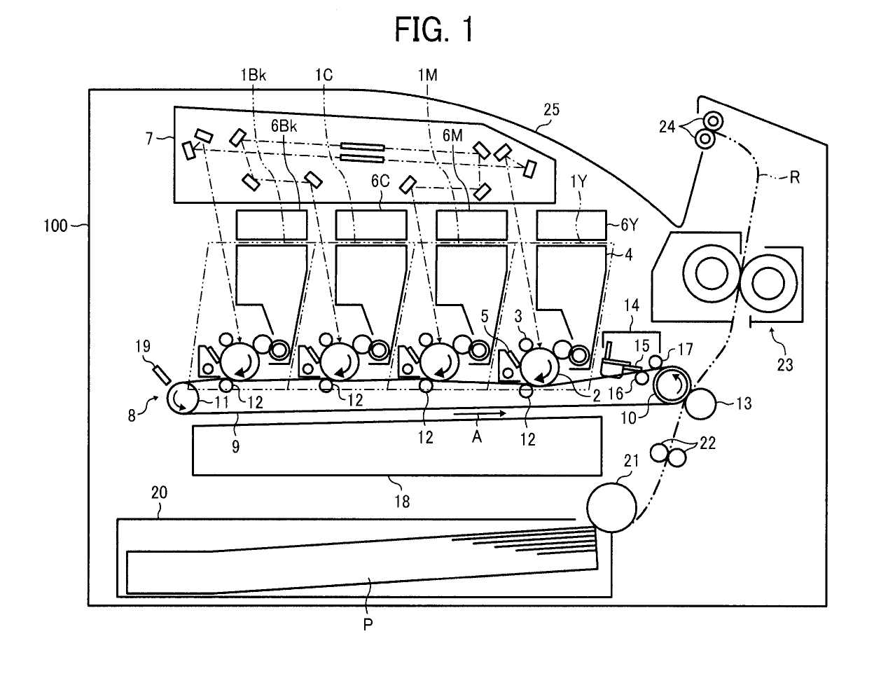

Referring now to the drawings, wherein like reference numerals designate identical or corresponding parts throughout the several views thereof, and particularly to FIG. 1, a multicolor image forming apparatus according to an embodiment of the present invention is described.

It is to be noted that the suffixes Y, M, C, and Bk attached to each reference numeral indicate only that components indicated thereby are used for forming yellow, magenta, cyan, and black images, respectively, and hereinafter may be omitted when color discrimination is not necessary.

FIG. 1 is a schematic view of an image forming apparatus that in the present embodiment is a multicolor laser printer, for example.

An image forming apparatus 100 shown in FIG. 1 includes four process units 1Y, 1M, 1C, and 1Bk removably installable in an apparatus body thereof. The process units 1Y, 1M, 1C, and 1Bk are designed to form images of different decomposed color components of full-color images, namely, yellow (Y), magenta (M), cyan (C), and black (Bk). Each of the process units 1 includes a drum-shaped photoreceptor 2 serving as a latent image bearer, a changing device including a changing roller 3 to charge the surface of the photoreceptor 2, a development device 4 to supply toner to a latent image formed on the photoreceptor 2, and a cleaning unit 5 to clean the surface of the photoreceptor 2. It is to be noted that, in FIG. 1, the photoreceptor 2, the charging roller 3, the development device 4, and the cleaning unit 5 of only the process unit 1Y for yellow are given reference numerals, and reference numerals of those of other process units 1M, 1C, and 1Bk are omitted.

Above the development devices 4 of the respective process units 1, toner cartridges 6 serving as developer containers are removably mounted. Each of the toner cartridges 6 contains a color toner (developer) used in the corresponding process unit 1.

Additionally, an exposure unit 7 is provided above the apparatus body. The exposure unit 7 serves as a latent image forming unit to form latent images on surfaces of the photoreceptors 2. The exposure unit 7 includes a light source, a polygon mirror, an f-θ lens, and reflection mirrors, and is configured to direct a laser beam onto the surface of the photoreceptor 2 according to image data.

Additionally, a transfer device 8 is provided beneath the photoreceptors 2. The transfer device 8 includes an intermediate transfer belt 9 that can be an endless belt, a driving roller 10, a driven roller 11, four primary-transfer rollers 12 serving as primary transfer members, and a secondary-transfer roller 13 serving as a secondary transfer member. The intermediate transfer belt 9 is stretched around the driving roller 10 and the driven roller 11. As the driving roller 10 rotates counterclockwise in FIG. 1, the intermediate transfer belt 9 rotates in the direction indicated by arrow A shown in FIG. 1.

The four primary-transfer rollers 12 are disposed in contact with the respective photoreceptors 2 via the intermediate transfer belt 9. Thus, the photoreceptor 2 contacts the intermediate transfer belt 9, forming a primary-transfer nip therebetween, where toner is transferred to the photoreceptor 2. Each primary-transfer roller 12 is electrically connected to a power source and receives a predetermined amount of voltage including at least one of direct-current (DC) voltage and alternating current (AC) voltage.

The secondary-transfer roller 13 contacts the driving roller 10 via the intermediate transfer belt 9, thus forming a secondary-transfer nip between the secondary-transfer roller 13 and the intermediate transfer belt 9 for secondary image transfer. Similarly to the primary-transfer rollers 12, the secondary-transfer roller 13 is electrically connected to a power source and receives a predetermined amount of voltage including at least one of DC voltage and AC voltage.

Additionally, a belt cleaning unit 14 to clean the surface of the intermediate transfer belt 9 is provided facing a right end of the intermediate transfer belt 9 in FIG. 1. The belt cleaning unit 14 includes a cleaning blade 15 to contact an outer circumferential surface of the intermediate transfer belt 9, a backup roller 16 to support an end of the cleaning blade 15 from an inner circumferential side of the intermediate transfer belt 9, and a conveyance coil 17 to transport toner removed from the intermediate transfer belt 9. A waste toner conveyance hose (tube) extending from the belt cleaning unit 14 is connected to an inlet of a waste toner container 18 provided beneath the transfer device 8.

Additionally, a toner mark detector 19 is provided to a left portion of the transfer device 8 in FIG. 1. The toner mark detector 19 can be a reflection type optical sensor to detect the amount of toner adhering to the intermediate transfer belt 9 and the position of the toner image thereon for adjustment of the density and the position of the toner image.

Beneath the apparatus body, a sheet tray 20 for containing sheets P, serving as recording media, and a feed roller 21 to feed the sheets P from the sheet tray 20 are provided. The recording media include, in addition to standard copy paper, heavy paper, post cards, thin paper such as tracing paper, coated paper, overhead projector (OHP) films, and special purpose sheets.

A conveyance path R is formed inside the apparatus body for conveying the sheet P from the sheet tray 20 to the secondary-transfer nip and further outside the image forming apparatus 100. On the conveyance path R, a pair of registration rollers 22 (timing rollers) is provided between the feed roller 21 and the secondary-transfer roller 13. Additionally, a fixing device 23 to fix the toner image on the sheet P is provided on the conveyance path R downstream from the secondary-transfer roller 13 in the direction in which the sheet P is transported (hereinafter “sheet conveyance direction”). At the end of the conveyance path R, a pair of discharge rollers 24 is provided to discharge the sheet P to a discharge tray 25 provided on an upper face of the image forming apparatus 100.

The image forming apparatus 100 configured as described above operates as follows.

When image formation is started, the photoreceptors 2 in the respective process units 1 are rotated clockwise in FIG. 1, and the changing rollers 3 uniformly charge the surfaces of the photoreceptors 2 to a predetermined polarity. Then, the exposure unit 7 directs laser beams onto the charged surfaces of the respective photoreceptors 2 according to, for example, image data of originals read by a reading unit. Thus, electrostatic latent images are formed on the respective photoreceptors 2. More specifically, the exposure unit 6 directs the laser beams according to single color data, namely, yellow, cyan, magenta, and black color data decomposed from full-color image data to the surfaces of the photoreceptors 2. The electrostatic latent images formed on the photoreceptors 2 are developed into toner images with toner supplied by the respective development devices 4.

Meanwhile, the driving roller 10 rotates, and accordingly the intermediate transfer belt 9 rotates in the direction indicated by arrow A shown in FIG. 1. The predetermined voltage (i.e., transfer bias voltage), polarity of which is opposite of toner, is applied to the respective primary-transfer rollers 12, thus forming transfer electrical fields in the primary-transfer nips. The transfer bias voltage may be a constant voltage or voltage controlled in constant-current control method.

The transfer electrical fields generated in the primary-transfer nips transfer the toner images from the respective photoreceptors 2 and superimpose them one on another on the intermediate transfer belt 9. Thus, a multicolor toner image is formed on the intermediate transfer belt 9. After primary transfer, the cleaning units 5 remove toner remaining on the respective photoreceptors 2.

Beneath the apparatus body, the feed roller 21 starts rotating, sending out the sheet P from the sheet tray 20 to the conveyance path R. Then, the registration rollers 22 forward the sheet P to the secondary-transfer nip formed between the secondary-transfer roller 13 and the intermediate transfer belt 9, timed to coincide with the multicolor toner image (superimposed single-color toner images) formed on the intermediate transfer belt 9. At that time, the transfer bias voltage whose polarity is opposite that of the toner image on the intermediate transfer belt 9 is applied to the secondary-transfer roller 13, and thus the transfer electrical field is formed in the secondary-transfer nip.

When the rotating intermediate transfer belt 9 reaches the secondary-transfer nip, the toner image is transferred from the intermediate transfer belt 9 onto the sheet P by the transfer electrical fields generated in the secondary-transfer nip. The cleaning blade 15 of the belt cleaning unit 14 removes toner remaining on the intermediate transfer belt 9 (i.e., waste toner) after image transfer, and the waste toner is conveyed through the conveyance coil 17 to the waste toner container 18.

Subsequently, the toner image is fixed on the sheet P by the fixing device 23. The pair of discharge rollers 24 discharges the sheet P outside the apparatus, to the discharge tray 25.

It is to be noted that, although the description above concerns multicolor image formation, alternatively, the image forming apparatus 1000 can form single-color images, bicolor images, or three-color images using one, two, or three of the four process units 1.

Configurations of the development device and the toner cartridge according to the present embodiment are described below.

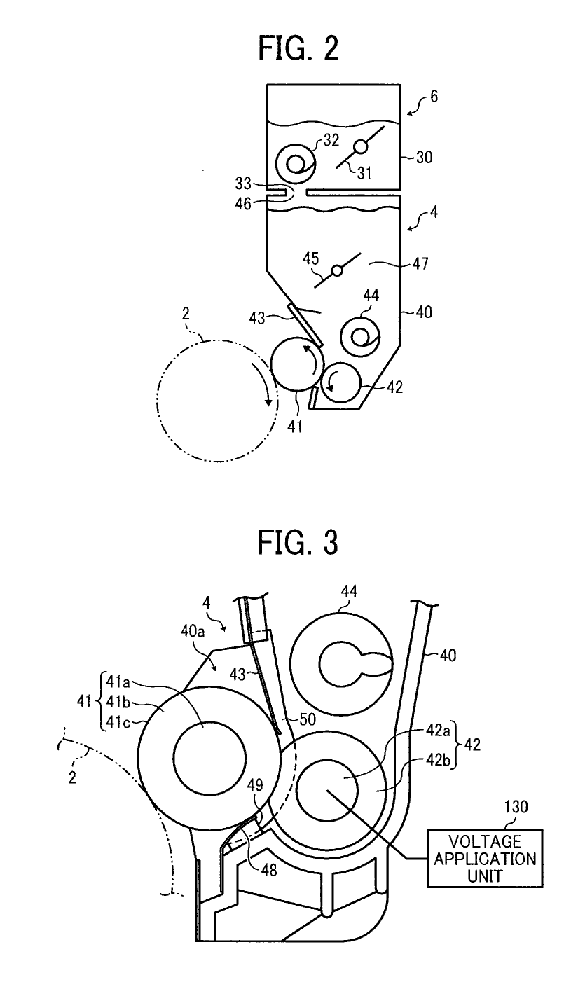

FIG. 2 is a schematic end-on axial view of the development device 4 and the toner cartridge 6.

As shown in FIG. 2, a paddle 31, serving as an agitator, and a conveyance screw 32, serving as a developer conveyance member to transport toner, are provided inside a container body 30 of the toner cartridge 6. An outlet 33 formed in the container body 30 is connected to a supply inlet 46 of the development device 4 when the toner cartridge 6 is mounted above the development device 4. As the conveyance screw 32 rotates, toner inside the container body 30 is transported axially, and toner is supplied from the outlet 33 to the development device 4. When the toner cartridge 6 is mounted in the image forming apparatus 100, the conveyance screw 32 can be connected to a driving unit provided in the apparatus body using a known device such as a clutch. The amount of toner supplied can be adjusted with the duration of driving of the driving unit. For example, the duration of driving may be changed depending the color of toner or changes in fluidity of toner caused by changes in temperature and humidity.

The development device 4 shown in FIG. 3 includes a development housing 40 in which a developer chamber 47 for containing toner, a development roller 41 serving as a developer bearer, a supply roller 42 serving as a developer supply member to supply toner to the development roller 41, a doctor blade 43 serving as a developer regulator to adjust the layer thickness of toner carried on the development roller 41, a conveyance screw 44 serving as a developer conveyance member to transport toner, and an agitator 45 to agitate toner. The development device 4 according to the present embodiment is so-called vertical type in which the developer chamber 47 is positioned above the development roller 41, the supply roller 42, and the doctor blade 43.

FIG. 3 is an enlarged cross-sectional view of the development device 4.

As shown in FIG. 3, an opening 40a is formed in a lower portion of the development housing 40. The opening 40a is positioned on the side facing the photoreceptor 2, and the development roller 41 is rotatably disposed in the opening 40a. The development roller 41 includes a metal core 41a, an elastic layer 41b formed of urethane rubber, silicone rubber, or the like, overlying the metal core 41a, and a surface layer (coat layer) 41c formed of acrylic resin, silicone resin, or the like, overlying the elastic layer 41b. The thickness of the surface layer 41c is preferably within a range of from 1 μm and 30 μm.

The supply roller 42 can be a sponge roller including a metal core 42a and an elastic layer 42b overlying the metal core 42a, constructed of an elastic foam member such as foamed polyurethane. The supply roller 42 is pressed against the development roller 41 to compress the elastic layer 42a, thereby forming a supply nip between the development roller 41 and the supply roller 42. Additionally, a voltage application unit 130 applies voltage to the supply roller 42. Specifically, voltage is applied to the supply roller 42 so that the electrical potential thereof is offset to the polarity identical to toner charging polarity relative to the electrical potential of the development roller 41.

The doctor blade 43 can be constructed of, for example, a planar metal having a thickness of about 0.1 mm. Steel used stainless (SUS) metal may be used for the doctor blade 43. A base end (upper end in FIG. 3) of the doctor blade 43 is fixed to a rim of the opening 40a formed in the development housing 40, and the other end (lower end in FIG. 3) contacts the surface of the development roller 41, forming a regulation nip.

Additionally, as shown in FIG. 3, an entrance seal 48 is provided beneath the development roller 41 to seal clearance between the development housing 40 and the development roller 41, adjacent to the opening 40a. The entrance seal 48 is a flexible sheet and can be constructed of urethane rubber, tetrafluoroethylene (PTFE) resin, polymeric polyethylene, or the like. A base end (lower end in FIG. 3) of the entrance seal 48 is fixed to the rim of the opening 40a formed in the development housing 40, and the other end (upper end in FIG. 3) contacts the surface of the development roller 41.

Further, a first face of the entrance seal 48 contacts the development roller 41, and a second face of the entrance seal 48, opposite the development roller 41, is supported by an elastic member 49 provided between the entrance seal 48 and the development housing 40.

In FIG. 3, reference numeral 50 represents lateral end seals that contact axial end portions of the development roller 41, sealing clearance between the development roller 41 and the development housing 40.

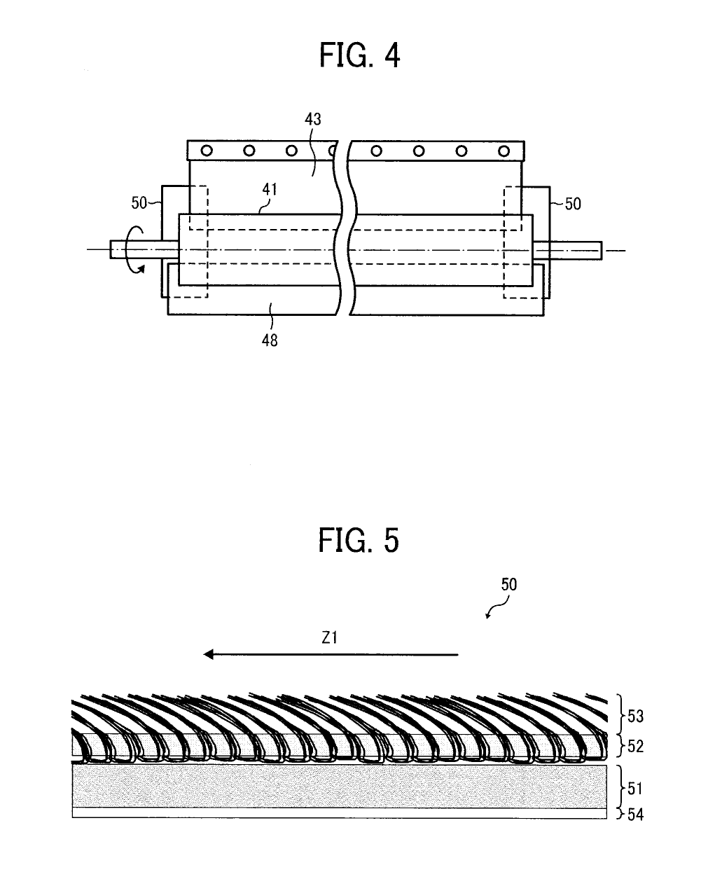

FIG. 4 is a side view of the lateral end seal 50 as viewed in a direction perpendicular to the axis of the development roller 41.

As shown in FIG. 4, the lateral end seal 50 is provided to either end portion (i.e., either lateral end) of the development roller 41 in the axial direction. The lateral end seal 50 can be bonded to the development housing 40 using double-sided adhesive tape or the like. In the lateral end portion of the development roller 41, the lateral end seal 50 hangs over to contact the development roller 41 as well as the doctor blade 43 and the entrance seal 48, which contacts the development roller 41. The lateral end seals 50 can inhibit leakage of toner from either lateral end of the development roller 41 outside the development housing 40. It is to be noted that the end of the doctor blade 43 is bent about 12 degrees to 18 degrees, and clearance may be allowed in a portion defined by the end of the doctor blade 43, the surface of the development roller 41, and the lateral end seal 50. The clearance, however, can be eliminated substantially by the lateral end seals 50 being pressed by pressure acting thereon when the development roller 41 is mounted in the development housing 40.

FIG. 5 is an enlarged cross-sectional view of the lateral end seal 50.

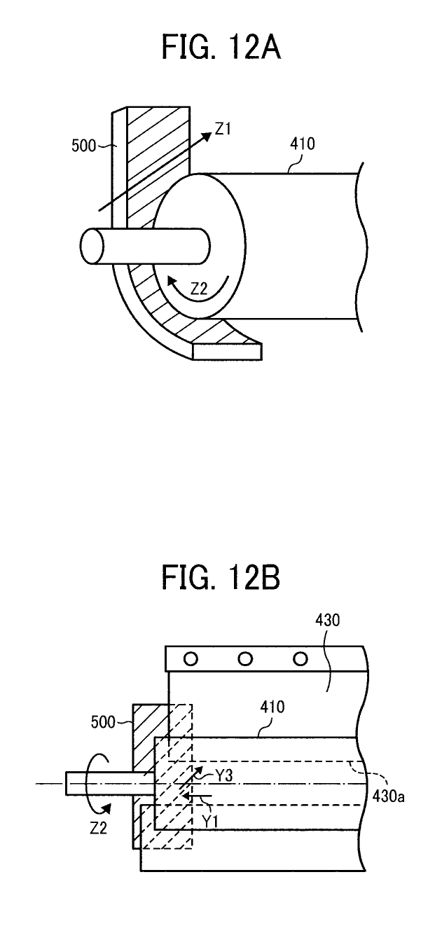

As shown in FIG. 5, the lateral end seal 50 includes an adhesive layer 54 constructed of, for example, a double-sided adhesive sheet, an elastic layer 51 provided to a surface of the adhesive layer 54 and constructed of, for example, sponge, a base sheet 52 provided to a surface of the elastic layer 51, and a raised fabric layer 53 constricted of multiple fibers projecting from the base sheet 52. The lateral end seals 50 are fixed to an inner face of the development housing 40 via the adhesive layer 54 with the raised fabric layer 53 facing and in contact with the development roller 41. The raised fabric layer 53 is processed such that the multiple fibers of the raised fabric layer 53 lean in a predetermined direction (indicated by arrow Z1 in FIGS. 5 and 12, hereinafter “fiber leaning direction Z1”).

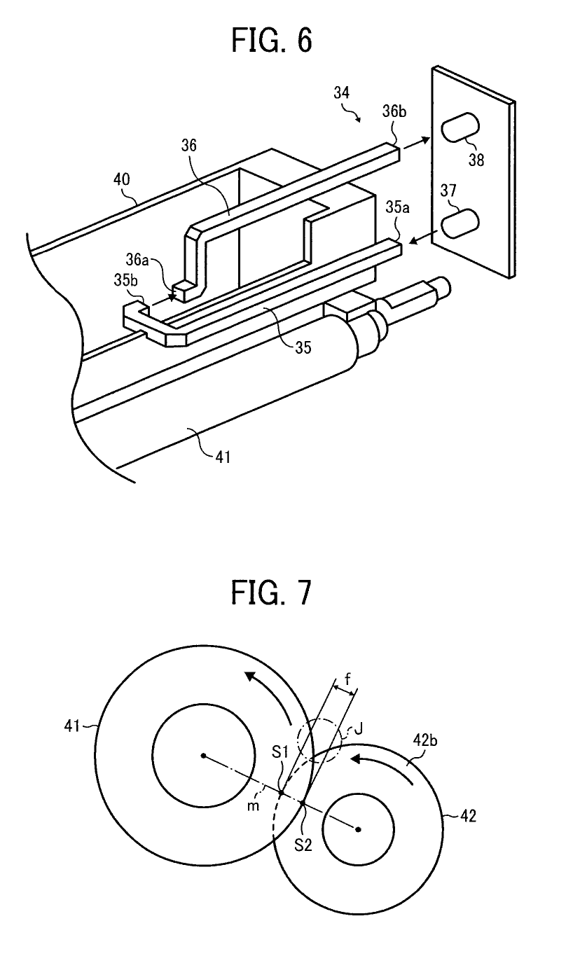

The development device 4 according to the present embodiment further includes a developer amount detector 34, shown in FIG. 6, to detect the amount of toner inside the developer chamber 47.

The developer amount detector 34 detects the amount of developer (i.e., toner) using an optical element in a light transmissive detection method. Specifically, the developer amount detector 34 includes a first light guide 35, a second light guide 36, a light-emitting element 37, and a light-receiving element 38. The first and second light guides 35 and 36 are provided to the development housing 40, and the light-emitting element 37 and the light-receiving element 38 are provided to the body of the image forming apparatus 100. The light emitted from the light-emitting element 37 enters a first end 35a of the first light guide 35 and exits from a second end 35b of the first light guide 35. Then, the light enters a first end 36a of the second light guide 36, which faces the second end 35b of the first light guide 35, exits from a second end 36b of the second light guide 36, and reaches the light-receiving element 38.

When the amount of developer in the development housing 40 is sufficient, the light is blocked by toner present in the gap between the second end 35b of the first light guide 35 and the first end 36a of the second light guide 36 facing each other. Thus, the light-receiving element 38 does not receive the light. However, as toner is consumed in printing, the level of toner in the development housing 40 descends below the first and second light guides 35 and 36, and no toner is present in the gap between the second end 35b of the first light guide 35 and the first end 36a of the second light guide 36. Accordingly, the light reaches the light-receiving element 38. A controller of the image forming apparatus 100 can recognize that the amount of toner in the development housing 40 is less than a threshold with the output from the light-receiving element 38 at that time.

Operations of the development device and the toner cartridge are described below with reference to FIG. 2.

Operations to supply toner from the toner cartridge are described below.

When the amount of toner inside the development housing 40 falls to or below a reference amount, toner is supplied to the development device 4. That is, toner supply is instructed when the developer amount detector 34 detects that the amount of toner inside the development housing 40 is smaller than the reference amount.

Upon a toner supply command, the conveyance screw 32 inside the toner cartridge 6 rotates, and toner is discharged from the outlet 33 to the development housing 40. Simultaneously with rotation of the conveyance screw 32, the paddle 31 starts rotating to agitate toner, thus facilitating toner supply. When the amount of toner inside the development housing 40 is increased to or greater than the reference amount, the light path between the light guides 35 and 36 is blocked, and the conveyance screw 32 and the paddle 31 are stopped. Thus, toner supply is completed.

Development operation of the development device 4 is described below.

When the start of image formation is instructed, toner inside the developer chamber 47 is agitated by the agitator 45 and supplied to the supply roller 42 by the conveyance screw 44. The toner supplied to the supply roller 42 is forwarded to the development roller 41 in the supply nip where toner is charged by friction between the supply roller 42 and the development roller 41. Additionally, the voltage application unit 130 applies voltage to the supply roller 42 to facilitate supply of toner to the development roller 41 by the electrical field generated between the supply roller 42 and the development roller 41. Alternatively, the voltage application unit 130 may apply voltage to the development roller 41 or both of the development roller 41 and the supply roller 42 to generate the electrical field for supplying toner from the supply roller 42 to the development roller 41.

While the toner carried on the development roller 41 passes through the regulation nip between the development roller 41 and the doctor blade 43, the amount of the toner is adjusted. Simultaneously, the toner is charged through friction. When the toner reaches the position facing the photoreceptor 2 (i.e., a development range), the toner electrostatically moves to the electrostatic latent image formed on the photoreceptor 2, thus developing it into a toner image.

Next, a specific feature of the present embodiment is described below.

In toner used in the present embodiment, silica particle whose surface is treated with silicone oil is externally added (i.e., an external additive) to toner mother particle. Such toner has an increased degree of coagulation or agglomeration and a lower degree of fluidity compared with toner to which lubricant such as silicone oil is not added. Accordingly, when such toner is used in conventional development devices, the amount of toner supplied from the supply roller to the development roller or the charge amount of toner tends to be insufficient, and it is possible that image density decreases toward the trailing end of the sheet.

Additionally, at least two of image forming components are often housed in a common unit casing, forming a process unit (modular unit) so that the multiple components can be replaced at once. When the process unit is separate from a toner cartridge, it is not necessary for the process unit to contain the amount of toner necessary for the period during which the process unit components are operable, thus reducing the size of the process unit and extending the operational life. In such process units, however, the capability of the development roller to carry toner thereon decreases gradually due to degradation over time, filming of toner components on the surface of the development roller, or the like. Accordingly, the decrease in image density can be more apparent when the toner having a higher agglomeration degree is used in the configuration in which the operational life of the process unit is extended.

In view of the foregoing, in the present embodiment, a biting mount of the supply roller 42 relative to the surface of the development roller 41 (hereinafter “biting amount f” shown in FIG. 7) is increased to enhance the capability of the supply roller 42 to supply toner to the development roller 41. The biting amount f of the supply roller 42 in this specification means the amount of deformation of the portion forming the supply nip when the supply roller 42 is pressed against the development roller 41 with a predetermined force. More specifically, referring to FIG. 7, reference character m represents a segment connecting a center of axis of the development roller 41 and that of the supply roller 42, S1 represents a surface position of the supply roller 42 on the segment m when the supply roller 42 does not contact the development roller 41, and S2 represents a surface position of the supply roller 42 on the segment m when the supply roller 42 is pressed against the development roller 41 with the predetermined force. The biting amount f can be defined as a difference between the surface position S1 and the surface position S2. In the present embodiment, the biting amount f is 0.7 mm or greater, for example.

When the biting amount f of the supply roller 42 is 0.7 mm or greater, the elastic layer 42b of the supply roller 42 can be compressed greater compared with a conventional configuration. With this configuration, even if toner having a higher degree of agglomeration is used, toner adhering to the supply roller 42 can be loosened in the supply nip or at an entrance J shown in FIG. 7 of the supply nip, thus facilitating supply of toner to the development roller 41. Additionally, when the biting amount f of the supply roller 42 is 0.7 mm or greater, frictional charging of toner in the supply nip can be facilitated, and electrostatic adhesion force of toner to the development roller 41 can increase.

Similar effects can be attained by increasing the contact pressure of the supply roller 42 against the development roller 41. Specifically, as the contact pressure of the supply roller 42 increases, the elastic layer 42b of the supply roller 42 is compressed more, which can facilitate loosening and frictional charging of toner. For example, in the present embodiment, the contact pressure (line contact pressure) of the supply roller 42 against the development roller 41 is 30 N/m or greater.

(Measurement of Contact Pressure of the Supply Roller)

The contact pressure of the supply roller 42 against the development roller 41 can be measured as follows.

Place the supply roller 42 on a flat plate, and attach plumbs or weights at both ends of the metal core to apply load thereto in the direction of the gravity. A contact pressure P (N/m) of the supply roller 42 can be calculated using the following formula when the biting amount of the supply roller 42 reaches the predetermined amount,

P=(A+B)×g/L Formula 1

wherein A represents the weight (kg) of the plumbs, B represents the weight (kg) of the supply roller 42, g represents the acceleration of gravity (m/s²), and L represents the axial length (m) of the elastic layer 42b of the supply roller 42.

The capability to supply toner to the development roller 41 can be increased by setting the biting amount or contact pressure of the supply roller 42 as described above. To further enhance the toner supply capability, the strength of the electrical field between the supply roller 42 and the development roller 41 may be increased. More specifically, it is preferable that voltage is applied to the supply roller 42 or the development roller 41 so that the electrical potential of the supply roller 42 is offset by 100 V or greater to the polarity of toner charging relative to the electrical potential of the development roller 41. Accordingly, the electrical field between the supply roller 42 and the development roller 41 can be stronger, and the Coulomb force to move toner toward the development roller 41 increases, facilitating supply of toner to the development roller 41.

Additionally, the volume resistivity of the supply roller 42 is preferably 1.0×10⁶Ω or smaller. Reduction in the volume resistivity of the supply roller 42 can increase the strength of the electrical field between the supply roller 42 and the development roller 41, thereby further facilitating the toner supply capability.

(Measurement of the Volume Resistivity of the Supply Roller)

The volume resistivity of the supply roller 42 can be measured as follows.

Dispose the supply roller 42 in contact with a metal electrode roller, and apply a load of 13 N thereto. Rotate the metal electrode roller while applying a voltage of 10 V thereto, thereby causing the supply roller 42 to rotate at the velocity of 20 rpm. The volume resistivity can be obtained based on a mean value of electrical current per one revolution of the supply roller 42.

Additionally, it is preferred that the elastic layer 42b of the supply roller 42, which is constructed of foamed elastic material, has a mean diameter of foam cells of 250 μm or smaller. When the mean diameter of foam cells is smaller, the supply roller 42 can contact the development roller 41 with a uniform contact pressure, thereby inhibiting unevenness in toner supply to the development roller 41.

(Measurement of the Mean Diameter of Foam Cells)

The mean diameter of foam cells of the supply roller 42 can be measured as follows.

Take a photograph of the surface of the supply roller 42 using, for example, a digital micro scope VI-IX-500 from Keyence corporation, and measure the diameter of foam cells that are substantially hemispherical. It is to be noted that, there are cells that are covered with a membrane and closed although foamed, or the opening is smaller in size than the foam even if the cell is open. Accordingly, 20 cells that are foamed and bulge are selected, and a mean value among them is calculated.

Descriptions are given below of experiments performed to examine effects of the above-described embodiments.

Initially, a toner manufacturing method used in the experiment is described below.

(Synthesis of Polyester)

Charge a reaction vessel equipped with a condenser, a stirrer, and a nitrogen inlet pipe with 235 parts of ethylene oxide 2 mol adduct of bisphenol A, 525 parts of propylene oxide 3 mol adduct of bisphenol A, 205 parts of terephthalic acid, 47 parts of adipic acid, and 2 parts of dibutyltin oxide. Subject the mixture to a reaction for 8 hours at 230° C. under normal pressure and subsequent 5 hours under reduced pressures of 10 to 15 mmHg. After adding 46 parts of trimellitic anhydride, further subject the mixture to a reaction for 2 hours at 180° C. under normal pressure. Thus, polyester is prepared. The polyester has a number average molecular weight of 2,600, a weight average molecular weight of 6,900, a glass transition temperature (Tg) of 44° C., and an acid value of 26 mgKOH/g.

(Synthesis of Prepolymer)

Charge a reaction vessel equipped with a condenser, a stirrer, and a nitrogen inlet pipe with 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. Subject the mixture to a reaction for 8 hours at 230° C. under normal pressure and subsequent 5 hours under reduced pressures of 10 to 15 mmHg. Thus, an intermediate polyester is prepared. The intermediate polyester has a number average molecular weight of 2,100, a weight average molecular weight of 9,500, a glass transition temperature (Tg) of 55° C., an acid value of 0.5 mgKOH/g, and a hydroxyl value of 49 mgKOH/g.

Charge another reaction vessel equipped with a condenser, a stirrer, and a nitrogen inlet pipe with 411 parts of the intermediate polyester, 89 parts of isophorone diisocyanate, and 500 parts of ethyl acetate. Subject the mixture to a reaction for 5 hours at 100° C. Thus, prepolymer is prepared. The prepolymer includes 1.53% of free isocyanates.

(Preparation of Master Batch)

Mix 40 parts of carbon black (REGAL 400R manufactured by Cabot Corporation), binder resin, 60 parts of polyester resin (RS801 (from Sanyo Chemical Industries, Ltd., acid value 10, Mw2000, Tg 64), and 30 part of water using a Henschel mixer to attain a mixture of pigment coagulation sopped in water. Knead the resulting mixture by a double roll for 45 minutes at 130° C. Pulverize the mixture into particles of 1 mm by a pulverizer. Thus, a master batch is prepared.

(Preparation of Pigment and Wax Aqueous Dispersion)

Charge a reaction vessel equipped with a stirrer and a thermometer with 545 parts of the above-described polyester, 181 parts of paraffin wax, and 1,450 parts of ethyl acetate. Heat the mixture to 80° C. while agitating it, keep it at 80° C. for 5 hours, and cool it to 30° C. over a period of 1 hour. Further mix 500 parts of the master batch, 100 parts of charge controller, and 100 parts of ethyl acetate in the mixture for 1 hour.

Thereafter, subject 1,500 parts of the resulting mixture to a dispersion treatment using a bead mill, ULTRAVISCOMILL (trademark) from Aimex Co., Ltd., filled with 80% by volume of zirconia beads having a diameter of 0.5 mm, at a liquid feeding speed of 1 kg/hour and a disc peripheral speed of 6 m/sec. Repeat this dispersing operation 3 times (3 passes) to disperse carbon black and wax. Subsequently, add 425 parts of the polyester and 230 parts thereto, and disperse it once using the bead mill under the above-described conditions (one pass) to attain the pigment and was dispersion. Add ethyl acetate to adjust the solid concentration of the pigment and wax dispersion to 50% at 130° C. for 30 min.

(Preparation of Aqueous Phase)

Mix and agitate 970 parts of ion-exchange water, 40 parts of 25% by weight aqueous dispersion of fine particles of organic resin (i.e., a copolymer of styrene, methacrylic acid, butyl acrylate, and a sodium salt of a sulfate of ethylene oxide adduct of methacrylic acid) for dispersion stability, 140 parts of a 48.5% aqueous solution of dodecyl diphenyl ether sodium disulfonate (ELEMINOL MON-7 from Sanyo Chemical Industries, Ltd.), and 90 parts, thereby attaining milky whitish liquid is prepared, which is the aqueous phase.

(Emulsification)

Mix 975 parts of the pigment and wax dispersion, 2.6 parts of amine such as isophoronediamine by a TK HOMOMIXER (from Primix Corporation) at a revolution of 5,000 rpm for 1 minute, after which 1200 parts of the above aqueous phase is mixed thereto. Mix for 20 minutes the mixture at a revolution of 8,000 to 13,000 rpm, thereby attaining emulsion slurry.

(Solvent Removal)

Heat the emulsion slurry contained in a vessel equipped with a stirrer and a thermometer, at 30° C. for 8 hours to remove the organic solvent. Thus, a dispersion slurry is prepared.

(Cleaning and Dry)

After filtering dispersion slurry under reduced pressure,

(1) mix the filtered wet cake with 100 parts of ion-exchange water by a TK HOMOMIXER at a revolution of 12,000 rpm for 10 minutes, followed by filtering. Thus a wet cake (1) is obtained. Thus a wet cake (1) is obtained. The filtered liquid is milky whitish.

(2) Mix the wet cake (1) with 900 parts of ion-exchange water by a TK HOMOMIXER at a revolution of 12,000 rpm for 30 minutes, with supersonic vibration. Thus, the wet cake was filtered under reduced pressure. Repeat this process until the degree of electrical conduction of the slurry liquid is 10 μC/cm or lower.

(3) Mix the slurry (2) with 100 parts of a 10% hydrochloric acid to adjust pH of the slurry to 4. Agitate it by three one motor for 30 minutes and then filter it.

(4) Mix the filtered cake (3) with 100 parts of ion-exchange water by a TK HOMOMIXER at a revolution of 12,000 rpm for 10 minutes, followed by filtering. Repeat this process until the degree of electrical conduction of the slurry liquid becomes 10 μC/cm or lower.

Dry the filtered cake by a drier at 42° C. for 48 hours and then sieve it with a mesh having openings of 75 μm. Thus, a toner mother particle is prepared. The toner mother particle has a mean circularity of 0.974, a volume average particle size (Dv) of 6.3 μm, a number average particle size (Dp) of 5.3 μm, a particle diameter distribution (Dv/Dp) of 1.19.

Mix the mother particle with fine silica particles available commercially by a HENSCHEL MIXER, filter it with a sieve of opening size of 60 μm, thereby removing rough particles or aggregation. Thus, toner is produced.

Employing the above-described method, toners 1 to 3 are produced.

(Toner 1)

Mix, in a Henschel mixer, 100 parts of the above mother particle and 1 part of commercially available silica particle such as H20TM (from Clariant Japan, Co., Ltd, having a mean particle size of 12 nm, without silicone oil treatment), and 2 parts of RY50 (from Nippon Aerosil, co., Ltd, having a mean particle size of 40 nm, with silicone oil treatment), and filter it with a sieve of opening size of 60 μm, thereby removing rough particles or aggregation. Thus, toner 1 is produced. Toner 1 has a degree of agglomeration of 54.4% under accelerated test conditions described below.

(Toner 2)

Mix, in a Henschel mixer, 100 parts of the above mother particle and 1 part of commercially available silica particle such as H20TM (from Clariant Japan Co., Ltd, having a mean particle size of 12 nm, without silicone oil treatment), and 2 parts of RX50 (from Nippon Aerosil Co., Ltd, having a mean particle size of 40 nm, without silicone oil treatment), and filter it with a sieve of opening size of 60 μm, thereby removing rough particles or aggregation. Thus, toner 2 is produced. Toner 2 has a degree of agglomeration of 40.3% under accelerated test conditions described below.

(Toner 3)

Toner 3 is produced similarly to toner 1 except that the amount of RY50 is changed to 3 parts. Toner 3 has a degree of agglomeration of 84.7% under accelerated test conditions described below.

(Degree of Agglomeration Under Accelerated Test Conditions)

The degree of agglomeration can be measured as follows using, for example, a powder tester from Hosokawa Micron Corporation. Set the following attachments on a vibrating table in the order of:

a vibro-shoot;

a packing;

a space ring;

three types of screens (upper>middle>lower); and

a pressing bar.

These are fixed by knob nuts, and the vibrating table is operated under the conditions below:

Screen opening (upper): 75 μm;

Screen opening (middle): 45 μm;

Screen opening (lower): 20 μm;

Vibration amplitude: 1 mm;

Sample mass: 2 g; and

Vibrating period: 10 seconds.

The degree of agglomeration used in this specification is the sum of following three values. That is, the degree of agglomeration is (a)+(b)+(c).

[Weight percent of powder remaining on the upper sieve]×1 (a),

[Weight percent of powder remaining on the middle sieve]×0.6 (b), and

[Weight of powder remaining on the lower sieve]×0.2 (c)

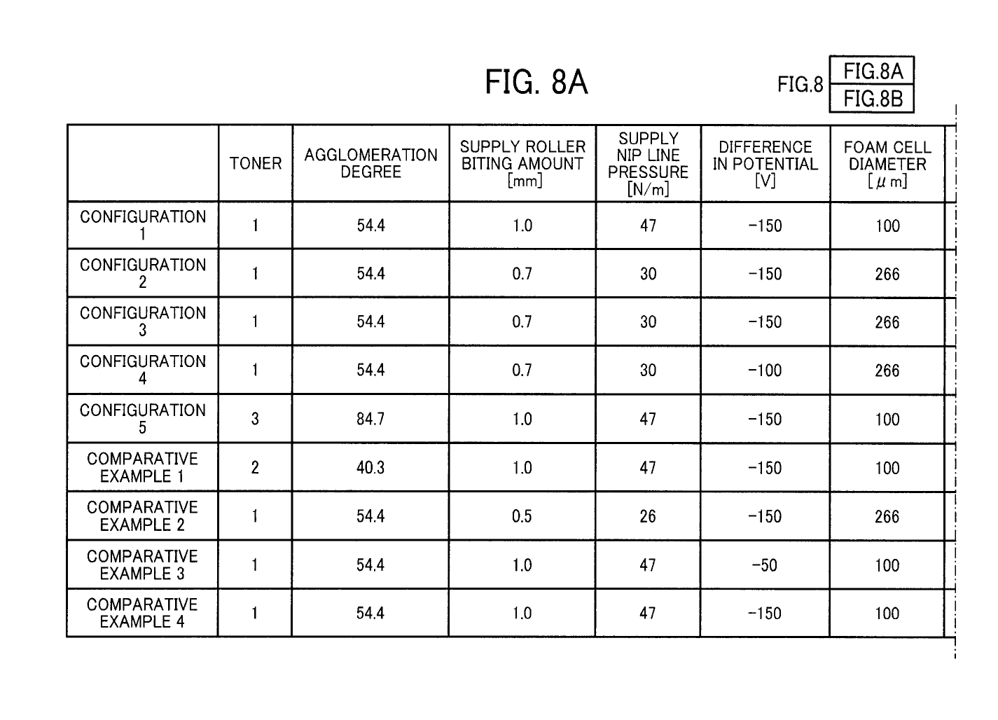

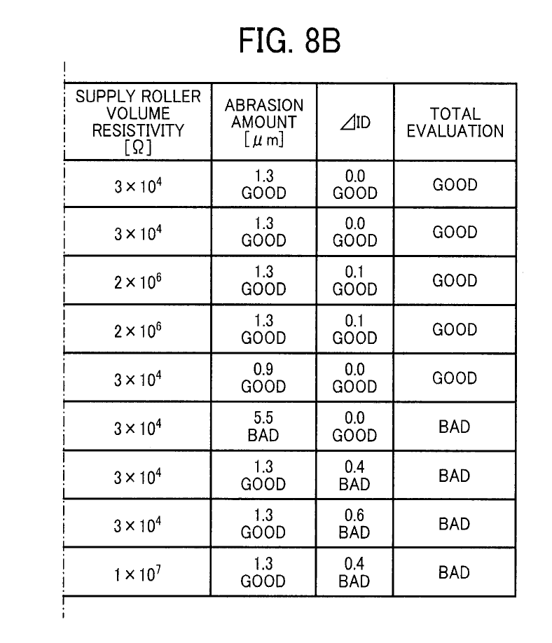

FIG. 8 is a table showing comparison results of configurations 1 through 5 according to the present embodiment and comparative examples 1 through 4.

To achieve the comparison results, a color printer, Ricoh IPSiO SP C310 was converted so that the process units 1 and the toner cartridges 6 shown in FIG. 2 were inserted therein. Additionally, the process units 1 were driven using connection to the motor for image formation driving. To drive the toner cartridges 6, the drive source for process cartridges were modified to connect to the toner cartridges 6 using a clutch. The drive source and the drive gears for the toner cartridges 6 were connected as required to enable toner supply.

Configurations and comparative examples used in the evaluation are described below.

(Configuration 1)

Toner used in configuration 1 is the above-described toner 1, which includes silicone oil. The supply roller 42 used in configuration 1 includes the metal core roller and the elastic layer 42b formed of foamed polyurethane, and the mean diameter of foam cells is 100 μm. The supply roller 42 has an external diameter of 13.4 mm and a volume resistivity of 3×10⁴Ω. Further, the biting amount of the supply roller 42 relative to the development roller 41 is 1 mm, and the contact pressure is 47 N/m. The voltage applied to the development roller 41 is −200 V, and the voltage applied to the supply roller 42 is −350 V. That is, the potential of the supply roller 42 relative to that of the development roller 41 is different by −150 V.

(Configuration 2)

In configuration 2, the elastic layer 42b of the supply roller 42 and the external diameter of the supply roller 42 are different from those of configuration 1. Specifically, the external diameter of the supply roller 42 is changed from 13.4 mm to 12.8 mm, and the mean diameter of foam cells is changed from 100 μm to 266 μm. Accordingly, the biting amount and contact pressure of the supply roller 42 are changed to 0.7 mm, and 30 N/m, respectively.

(Configuration 3)

Configuration 3 is similar to configuration 2 except the elastic layer 42b of the supply roller 42. Specifically, the volume resistivity thereof is changed from 3×10⁴Ω to 2×10⁶Ω.

(Configuration 4)

Configuration 4 is similar to configuration 3 except that the voltage applied to the supply roller 42 is changed from −350 V to −300 V. That is, the potential of the supply roller 42 relative to that of the development roller 41 is different by −100 V.

(Configuration 5)

Configuration 5 is similar to configuration 1 except that toner 1 is changed to toner 3 having a higher degree of agglomeration under accelerated test conditions.

### Comparative Example 1

Comparative example 1 is similar to configuration 1 except that toner 1 is changed to toner 2 that does not include silicone oil.

### Comparative Example 2

Comparative example 2 is similar to configuration 2 except that the external diameter of the supply roller 42 is changed from 12.8 mm to 12.4 mm. Accordingly, the biting amount of the supply roller 42 is changed from 0.7 mm to 0.5 mm, and the contact pressure is 26 N/m.

### Comparative Example 3

Comparative example 3 is similar to configuration 1 except that the voltage applied to the supply roller 42 is changed from −350 V to −250 V. That is, the potential of the supply roller 42 relative to that of the development roller 41 is different by −50 V.

### Comparative Example 4

Comparative example 4 is similar to configuration 1 except the elastic layer 42b of the supply roller 42. Specifically, the volume resistivity thereof is changed from 3×10⁴Ω to 1×10⁷Ω.

Configurations 1 through 5 and comparative examples 1 through 4 were evaluated regarding image density and the amount of abrasion of the photoreceptor 2 as follows.

(Evaluation of Image Density)

A solid image occupying an entire image area of an A4 sheet was output until the travel distance (amount of rotation) of the photoreceptor 2 reached 5000 m, and the image density at the leading end and trailing end of the sheet were measured using an X-Rite reflective densitometer, X-Rite 310. Subsequently, an image density difference ΔID was calculated by deducting the image density at the trailing end from the image density at the leading end. If ΔID≦0.1, the image density at the trailing end was deemed a desired density and judged “good”. If ΔID>0.1, the image density at the trailing end was deemed insufficient and judged “bad”.

(Evaluation Method of Abrasion of the Photoreceptor)

Before and after the travel distance of the photoreceptor 2 reached 5000 m, the thickness of the photosensitive layer was measured using a coating thickness measuring device, Fischerscope MMS from Fischer Instruments K.K. The abrasion amount criterion was set at 2.5 μm. That is, the abrasion amount was judged “good” when the abrasion amount of the surface of the photoreceptor 2 calculated from the measurement value was 2.5 μm or less and judged “bad” when the abrasion amount exceeded 2.5 μm.

(Total Evaluation)

The total evaluation is judged “good” only when both of the image density difference ΔID and the abrasion amount are judged “good”. When one of or both of the judgment items are “bad”, the total evaluation is “bad”.

The evaluation results are described in further detail below.

As it can be known from the table shown in FIG. 8, in configurations 1 through 5 according to the present embodiments, both of the abrasion amount of the photoreceptor 2 and the image density difference ΔID are “good”, and accordingly the total evaluation is “good”. By contrast, in comparative examples 1 through 4, one of the abrasion amount of the photoreceptor 2 and the image density difference ΔID is “bad”, and accordingly the total evaluation is “bad”.

Specifically, in comparative example 1, the abrasion amount is judged “bad”. It can be considered that alleviation of surface abrasion of the photoreceptor 2 is insufficient in comparative example 1 because toner 2 without silicone oil is used. By contrast, in comparative examples 2 through 4 and configurations 1 through 5 according to the present embodiment, toner 1 or 3 that includes silicone oil is used, and the abrasion amount is judged “good”.

In comparative examples 2 through 4, however, the image density difference ΔID is “bad”. It can be deemed that the amount of toner supplied to the development roller 41 is insufficient in the comparative examples 2 through 4 because agglomeration degree of toner 1 that includes silicone oil is higher.

Specifically, the biting amount (0.5 mm) and contact pressure (26 N/m) of the supply roller 42 in comparative example 2 are smaller than the ranges of the biting amount (0.7 mm or greater) and the contact pressure (30 N/m or greater) that are desirable when toner having a higher degree of agglomeration is used. Accordingly, in comparative example 2, loosening of toner and frictional charging of toner in the supply nip are insufficient, increasing the image density difference ΔID.

Additionally, in comparative example 3, the potential difference (50 V) of the supply roller 42 from that of the development roller 41 is smaller than the reference value (100 V or greater) desirable when toner having a higher degree of agglomeration is used. Accordingly, in comparative example 3, the strength of electrical field between the supply roller 42 and the development roller 41 is insufficient, increasing the image density difference ΔID.

In comparative example 4, the volume resistivity (1.0×10⁷Ω) of the supply roller 42 is greater than the reference value (1.0×10⁶Ω or less) desirable when toner having a higher degree of agglomeration is used. Accordingly, in comparative example 4, the strength of electrical field between the supply roller 42 and the development roller 41 is reduced, and the capability to supply toner to the development roller 41 is reduced, thereby increasing the image density difference ΔID.

By contrast, in configurations 1 through 5 according to the present embodiments, all of the biting amount, contact pressure, and volume resistivity of the supply roller 42; and the potential difference of the supply roller 42 from that of the development roller 41 are set to the above-described desirable values. Consequently, it can be deemed that the capability to supply toner to the development roller 41 increases, and satisfactory images can be produced even when toner having a higher agglomeration degree (toner 1 or 3) is used.

Further, configuration 5 employs toner 3 having the agglomeration degree higher than that of toner 1. Accordingly, it can be experimentally confirmed that the present embodiment can be advantageous to a wide range of agglomeration degree under accelerated test conditions, an agglomeration degree of 54% or greater.

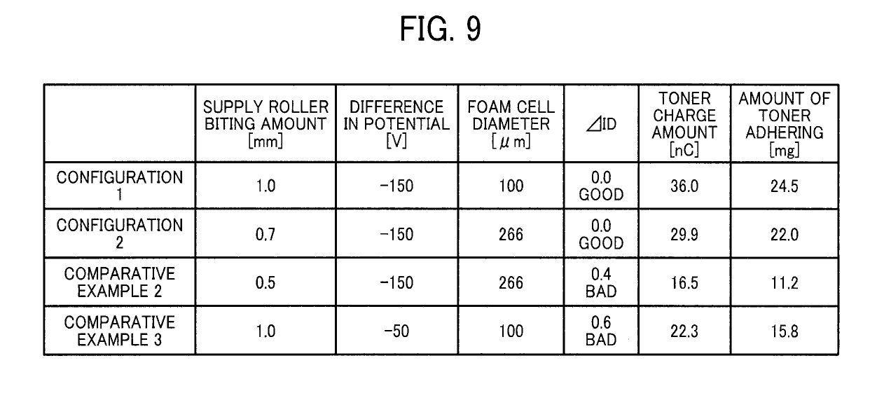

Use of the present embodiment can be considered to enhance the toner charging amount on the development roller 41 and the amount of toner adhering to the development roller 41, thereby attain the above-described results. To confirm it, the toner charging amount and the amount of toner adhering in configurations 1 and 2 and comparative examples 2 and 3 are shown in FIG. 9.

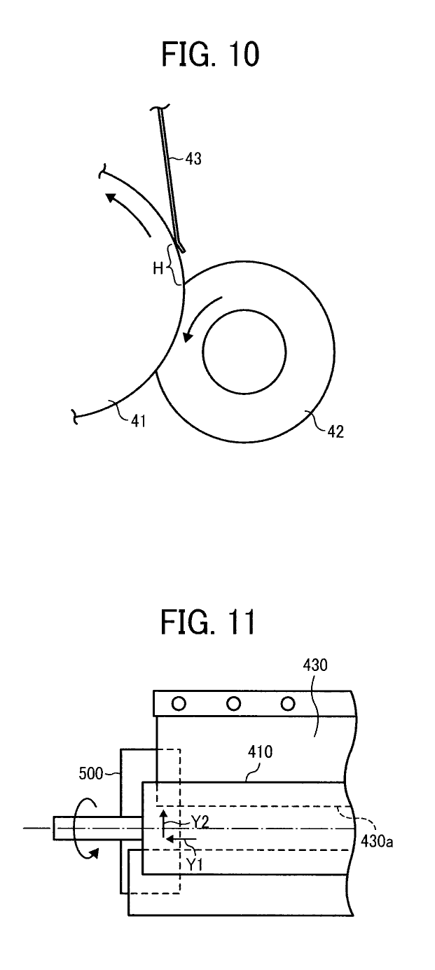

Specifically, referring to FIG. 10, the amount of charge of toner and the amount of toner adhering to the surface of the development roller 41 was measured in a range H between the supply nip of the supply roller 42 and the regulation nip of the doctor blade 43.

In FIG. 9, the biting amount of the supply roller 42 in configuration 2 is greater than that of comparative example 2. As a result, the charge amount and adhesion amount of toner in configuration 2 are greater than those in comparative example 2. It s can be considered that, in configuration 2, loosening and frictional charging of toner are improved by the increase in the biting amount.

Additionally, in FIG. 9, the absolute value of the potential difference of the supply roller 42 from that of the development roller 41 in configuration 1 is greater than that of comparative example 3. As a result, the charge amount and adhesion amount of toner in configuration 1 are greater than those in comparative example 3. It s can be considered that, in configuration 1, the strength of electrical field between the supply roller 42 and the development roller 41 increases, thus enhancing the capability to supply toner to the development roller 41.

As described above, according to the present embodiment, when the biting amount of the supply roller 42 is 0.7 mm or greater, or the contact pressure of the supply roller 42 is 30 N/m or greater, the charge amount or adhesion amount of toner on the development roller 41 can be increased even when toner having a higher agglomeration degree (54% or greater under the accelerated conditions) is used. Since the present embodiment can improve the capability to supply toner to the development roller 41, decreases in the density of images formed of the toner having a higher agglomeration degree can be alleviated, thereby producing images of satisfactory quality. The toner supply capability can further improve when the potential of the supply roller 42 is offset 100 V or greater to the polarity of toner charging relative to that of the development roller 41.

Additionally, in configurations in which the process unit 1 is separate from the toner cartridge 6 to extend the operational life thereof as in the present embodiment, decreases in image density are likely to become apparent over time when toner having a higher agglomeration degree is used. Therefore, the features of the present embodiment can attain higher effects particularly in such configurations since a desired capability to supply toner to the development roller 41 can be maintained for long time.

Additionally, when the volume resistivity of the supply roller 42 is 1.0×10⁶Ω or lower, the electrical field between the supply roller 42 and the development roller 41 can be stronger, thereby further enhancing the toner supply capability. When the mean diameter of foam cells of the elastic layer 42b of the supply roller 42 is 250 μm or smaller, the supply roller 42 can contact the development roller 41 with a uniform contact pressure, thereby inhibiting unevenness in the amount of toner supplied to the development roller 41.

Next, other features of the present embodiment are described.

As shown in FIGS. 3 and 4, the lateral end seals 50 are provided to the both ends of the development roller 41 to inhibit leakage of toner therefrom. Such lateral end seals are used also in conventional configurations. In conventional configurations using such lateral end seals, it is possible unintended vertical lines appear in output images, or toner leaks from between the lateral end seal and the development housing (casing) when toner including a lubricating component is used. These inconveniences can be caused by coagulation or firm adhesion of toner due to heat generated by friction between the lateral end seal and the development roller.

Specifically, since toner to which a lubricating component is added has a higher degree of coagulation and a lower degree of fluidity, toner tends to be retained on the longitudinal end sides of the regulation blade or doctor blade. As a result, heat generated by sliding contact between the development roller and the lateral end seal accumulates in the retained toner, thus fusing toner. Then, toner firmly adheres to the regulation blade (i.e., doctor blade 43). If firm adhesion of toner occurs in the image formation range, it hinders the regulation blade from leveling off toner on the development roller, resulting in unintended vertical lines appear in output images.

Additionally, if sealing by the lateral end seal is insufficient, toner can enter between the lateral end seal and the development roller and fused by heat generated by friction between the lateral end seal and the development roller. If toner coagulates between the lateral end seal and the development roller or firmly adheres thereto, the development roller can be abraded by the toner, resulting in leakage of toner. In particular, between the lateral end seal and the development roller, toner receives frictional heat directly, encouraging growth of firm adhesion of toner. Growth of firm adhesion of toner degrades sealing of the entrance seal at the opening formed in the development device, and toner leaks therefrom.

Additionally, referring to a comparative configuration shown in FIG. 11, if toner enters between a lateral end seal 500 and a development roller 410 as indicated by arrow Y1, toner moves in the direction indicated by arrow Y2, receiving rotational force from the development roller 410. Then, it is possible that the toner reaches an end 430a of a doctor blade 430. At the end 430a, the contact pressure of the doctor blade 430 is higher since the doctor blade 430 is sandwiched between the lateral end seal 500 and the development roller 410. Therefore, if toner reaches the end 430a of the doctor blade 430, firm adhesion of toner is caused more easily due to the higher contact pressure and the frictional heat.

Firm adhesion of toner can occur also when toner having a lower glass transition temperature (Tg) or toner of small particle diameter is used.

Additionally, such an inconvenience is likely to be more apparent in configurations in which the process unit 1 is separate from the toner cartridge 6.

For example, in a comparative development device, toner entering between the development roller and the lateral end seal may be returned to the center side in the axial direction of the development roller as follows.

Specifically, in the comparative configuration shown in FIGS. 12A and 12B, the fiber leaning direction Z1 of the lateral end seal 500 follows the direction indicated by arrow Z2 in which the development roller 410 rotates and inclined from the direction Z2 toward the axial center of the development roller 410. With this configuration, as shown in FIG. 12B, even if toner enters between the lateral end seal 500 and the development roller 410 as indicated by arrow Y1, toner can be returned as indicated by arrow Y3 along the fiber leaning direction Z1 of the lateral end seal 500 by rotation of the development roller 410. Thus, toner can be returned to the center side in the axial direction.

However, in the configuration shown in FIGS. 12A and 12B, there is a need for inhibiting firm adhesion of toner caused by frictional heat generated between the lateral end seal 500 and the development roller 410 when toner having a higher agglomeration degree and a lower fluidity is used.

In view of the foregoing, the present embodiment is designed to inhibit the above-described firm adhesion of toner when toner having a higher agglomeration degree is used.

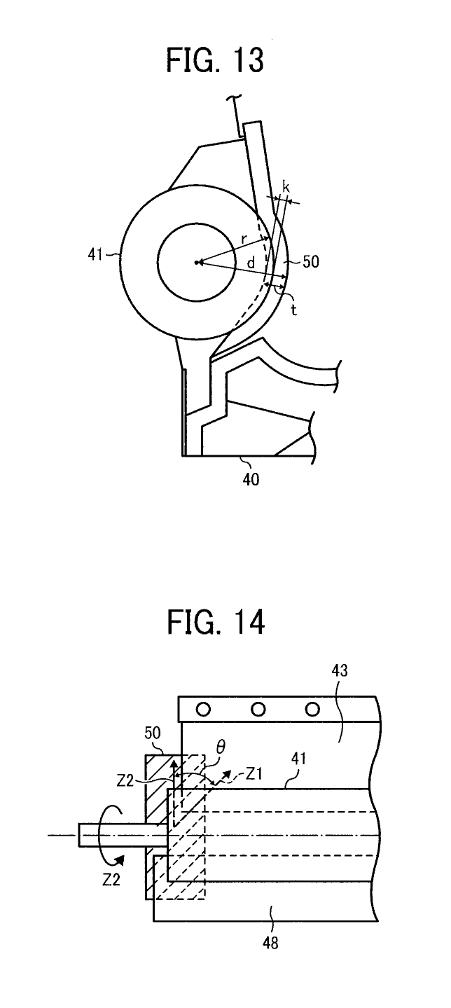

Specifically, referring to FIG. 13, when the lateral end seal 50 is pressed against the development roller 41 with a predetermined force, the portion forming the nip deforms a certain amount, which is referred to as a biting amount k of the lateral end seal 50 biting into the surface of the development roller 41. In the present embodiment, the biting amount k of the lateral end seal 50 into the development roller 41 is within a range from about 0.3 mm to 2.1 mm, for example.

It is to be noted that, although the lateral end seal 50 deforms (is compressed) also in portions where the lateral end seal 50 clamps the lateral ends of the doctor blade 43 or the entrance seal 48 (both shown in FIG. 4), the biting mount k does not means the deformation amount in that portions. That is, the deformation amount in a portion where the lateral end seal 50 directly contacts the development roller 41 is regarded as the biting amount k.

As shown in FIG. 13, when r represents a radius in millimeter of the development roller 41, t represents a thickness in millimeter of the lateral end seal 50 in the portion where the lateral end seal 50 contacts the development roller 41, and d represents a distance from the center of axis of the development roller 41 to the axial end portion of the development housing 40 where the lateral end seal 50 is bonded, the biting amount k can be expressed using formula 2 below. The thickness t of the lateral end seal 50 here means the length from the backside of the adhesive layer 54 shown in FIG. 5 to the tip of the fiber forming the raised fabric layer 53.

k=r+t−d Formula 2

Thus, in the present embodiment, the biting amount k of the lateral end seal 50 is within a range of from 0.3 mm to 2.1 mm (including 0.3 mm and 2.1 mm), thereby reducing the contact pressure between the lateral end seal 50 and the development roller 41 from that in conventional configurations. Accordingly, frictional heat between them can be restricted. This configuration can inhibit firm adhesion of toner caused by frictional heat between the lateral end seal 50 and the development roller 41 even when toner having a higher agglomeration degree is used.

It is to be noted that, although similar effects can be attained by increasing the contact pressure of the lateral end seal 50 against the development roller 41, to secure the sealing capability, the contact pressure (contact face pressure) of the lateral end seal 50 against the development roller 41 is preferably within a range of from 0.25 N/cm² to 7.5 N/cm² including these two values. The adjustment of the contact pressure of the lateral end seal 50 can inhibit frictional heat between the lateral end seal 50 and the development roller 41, and accordingly firm adhesion of toner can be inhibited.

Additionally, it is preferable that the contact pressure of the lateral end seal 50 against the development roller 41 increases from the axial ends to the axial center of the development roller 41. This configuration can make the contact pressure of the lateral end seal 50 greater on the side where toner enters and can secure inhibition of toner entering between the lateral end seal 50 and the development roller 41. By contrast, the contact pressure of the lateral end seal 50 decreases from the side where toner enters to the opposite side. Accordingly, generation of frictional heat can be reduced, thereby inhibiting firm adhesion of toner.

Additionally, similarly to the comparative configuration shown in FIGS. 12A and 12B, the fiber leaning direction Z1 of the lateral end seal 50 according to the present embodiment follows the rotational direction Z2 of the development roller 41 (in particular, the rotational direction in the contact position between the development roller 41 and the lateral end seal 50) and is inclined toward the axial center of the development roller 41. That is, the fiber leaning direction Z1 is inclined toward the axial center as the position in the rotational direction of the development roller 41 goes downstream.

With this configuration, as shown in FIG. 12B, even if toner enters between the lateral end seal 50 and the development roller 41, toner can be returned to the axial center side along the fiber leaning direction of the lateral end seal 50 by rotation of the development roller 41. Thus, firm adhesion of toner can be prevented.

Additionally, referring to FIG. 14, it is preferable that an angle θ of the fiber leaning direction Z1 relative to the rotational direction Z2 of the development roller 41 (i.e., surface movement direction of the development roller 41 in the contact position with the lateral end seal 50) be 30° or greater and 60° or smaller. With the adjustment of the angle θ, toner can be moved in the fiber leaning direction Z1 using the rotational force of the development roller 41.

Additionally, it is preferable that the side (i.e., the contact side) of the lateral end seal 50 that contacts the development roller 41 is constructed of a fluorine material. In the present embodiment, the raised fabric layer 53 is on the contact side. When the contact side of the lateral end seal 50 is formed of a fluorine material, sliding against the development roller 41 can improve, and generation of frictional heat can be reduced further.

Additionally, the surface of the development roller 41 preferably has a JIS-A hardness of 60 degrees or lower. When the surface hardness of the development roller 41 is lower, the contact pressure of the lateral end seal 50 or that of the doctor blade 43 against the development roller 41 can be reduced, thus inhibiting firm adhesion of toner.

Effects of the above-described biting amount, contact pressure, and the angle θ of the fiber leaning direction Z1 of the lateral end seal 50 were experimentally evaluated as follows.

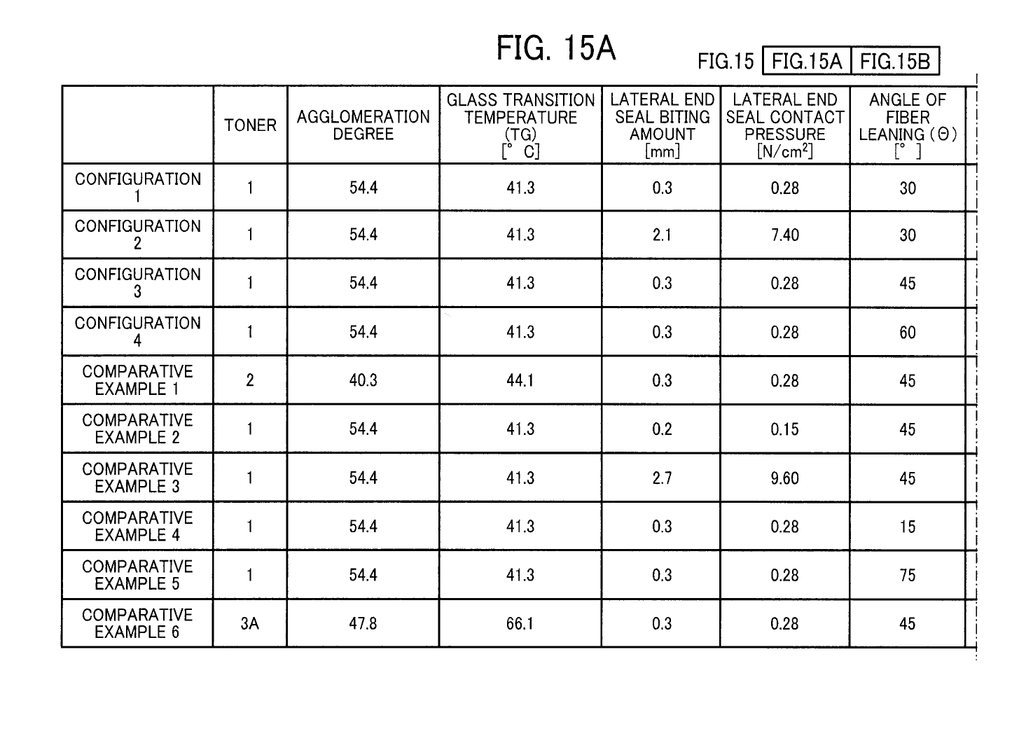

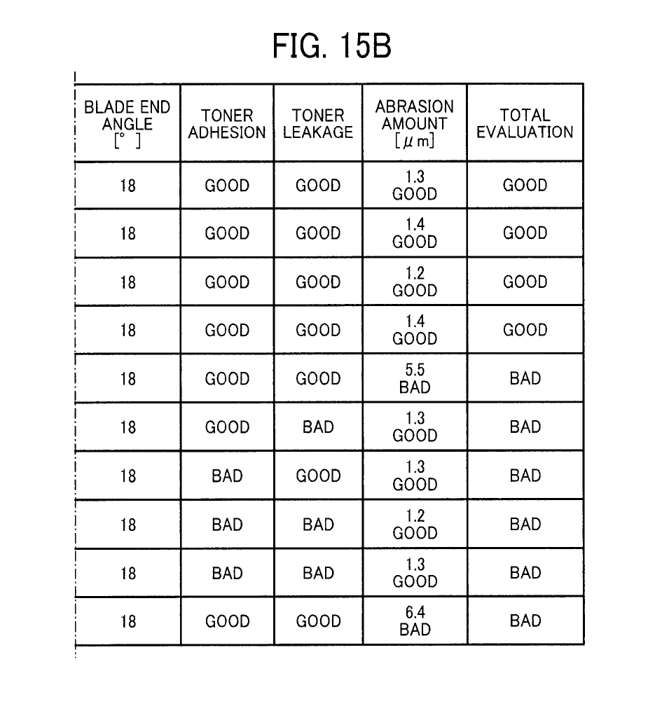

FIG. 15 shows comparison results of configurations 1 through 4 according to the present embodiment and comparative examples 1 through 6 regarding the configuration of the lateral end seal 50.

Three different types of toners were used in the evaluation shown in FIG. 3. Toners 1 and 2 shown in FIG. 3 are identical to toners 1 and 2 used in the evaluation shown in FIG. 8. Toner 3′ used in the evaluation shown in FIG. 3, however, is different from toner 3 used in the above-described evaluation. Toner 3A has a degree of agglomeration of 47.8% under the accelerated test conditions. For example, black toner for Ricoh IPSiO SP C310 can be used as toner 3A. Differently from toner 1 or 2, toner 3A is pulverized toner produced through pre-mixing treatment, melt-kneading, pulverization, classification, mixing with external additives, and filtering in that order. The degree of agglomeration under accelerated conditions was measured under the above-described method.

Glass transition temperatures (Tg) of toner 1, 2, and 3A are 41.3° C., 44.1° C., and 66.1° C., respectively, according to the measurement method described below.

(Measurement of Glass Transition Temperature)

The glass transition temperature (Tg) of toner can be measured using a differential scanning calorimeter, DSC-6220R from Seiko Instruments Inc., for example. Initially, heat the sample (i.e., toner) from the room temperature to 150° C. at a temperature rising speed of 10° C./min, and leave it at 150° C. for 10 minutes. Cool the sample to the room temperature and leave it for 10 minutes. Subsequently, again heat the sample to 150° C. at a temperature rising speed of 10° C./min. Then, the glass transition temperature can be obtained from the point of intersection of the base line lower than the glass transition temperature and the curve representing glass transition.

Conditions used in this evaluation are described below.

(Configuration 1)

Toner used in configuration 1 is the above-described toner 1, which includes silicone oil. The biting amount k and the contact pressure of the lateral end seal 50 against the development roller 41 are 0.3 mm and 0.28 N/cm², respectively. The angle θ of leaning of fibers of the lateral end seal 50 is 30 degrees. The end of the doctor blade 43 is bent 18 degrees.

(Configuration 2)

Configuration 2 is different from configuration 1 in that the biting amount k and the contact pressure of the lateral end seal 50 are increased to 2.1 mm and 7.4 N/cm², respectively.

(Configuration 3)

Configuration 3 is different from configuration 1 in that the angle θ of leaning of fibers of the lateral end seal 50 is 45 degrees.

(Configuration 4)

Configuration 4 is different from configuration 1 in that the angle θ of leaning of fibers of the lateral end seal 50 is 60 degrees.

### Comparative Example 1

Comparative example 1 is similar to configuration 3 except that toner 2 without silicone oil is used instead of toner 1.

### Comparative Example 2

Comparative example 2 is different from configuration 3 in that the biting amount and the contact pressure of the lateral end seal 50 to the development roller 41 are reduced to 0.2 mm and 0.15 N/cm², respectively.

### Comparative Example 3

Comparative example 3 is different from configuration 3 in that the biting amount k and the contact pressure of the lateral end seal 50 to the development roller 41 are increased to 2.7 mm and 9.6 N/cm², respectively.

### Comparative Example 4

Comparative example 4 is different from configuration 1 in that the angle θ of leaning of fibers of the lateral end seal 50 is 15 degrees.

### Comparative Example 5

Comparative example 5 is different from configuration 1 in that the angle θ of leaning of fibers of the lateral end seal 50 is 75 degrees.

### Comparative Example 6

Comparative example 6 is similar to configuration 3 except that toner 3A that does not include silicone oil is used instead of toner 1.

It is to be noted that the contact pressure of the lateral end seal 50 in configurations 1 to 4 and comparative examples 1 to 6 was calculated by dividing, with the contact area, the repulsive force at the portion where the lateral end seal 50 was compressed by the development roller 41.

Configurations 1 through 4 and comparative examples 1 through 6 were evaluated regarding adhesion of toner to the end of the doctor blade 43, leakage of toner, and the amount of abrasion of the photoreceptor 2.

(Evaluation of Firm Adhesion of Toner)

Images were formed using a multicolor printer similar to that used in the above-described evaluation under a temperature of 27° C. and a humidity of 80% until the travel distance (amount of rotation) of the photoreceptor 2 reached 5000 m. Then, the end of the doctor blade 43 was observed for toner adhesion. When no toner adhesion was observed, it was judged “good”, and, when toner adhesion was observed, it was judged “bad”.

(Evaluation of Leakage of Toner)

After the travel distance of the photoreceptor 2 reached 5000 m, the lateral end seal 50 was observed, and leakage of toner was checked. When no toner was present on the sealing face of the lateral end seal 50, the judgment was “good”, and, when toner is present, the judgment was “bad”.

(Evaluation Method of Abrasion of the Photoreceptor)

The abrasion of the photoreceptor 2 was evaluated similarly to the evaluation shown in FIG. 8.

(Total Evaluation)

Additionally, the total evaluation is deemed “good” only when both of the adhesion of toner, leakage of toner, and the abrasion amount are judged “good”. When one of or both of the judgment items are “bad”, the total evaluation is “bad”.

The evaluation results are described in further detail below.

As it can be known from FIG. 3, in configurations 1 through 4, all of toner adhesion, toner leakage, and the abrasion amount are “good”, and accordingly the total evaluation is “good”. By contrast, in comparative examples 1 through 6, one or more of the evaluation items are “bad”, and accordingly the total evaluation is “bad”.

Specifically, in comparative examples 1 and 6, the abrasion amount is “bad”. In comparative examples 1 and 6, alleviation of surface abrasion of the photoreceptor 2 can be considered insufficient because toner 2 or 3A without silicone oil is used. By contrast, in comparative examples 2 through 5 and configurations 1 through 4 according to the present embodiment, toner 1 that includes silicone oil is used, and the abrasion amount is “good”.

In comparative example 2, however, leakage of toner is judged “bad”. In comparative example 2, the biting amount k and contact pressure of the lateral end seal 50 are 0.2 mm and 0.15 N/cm², respectively, which are smaller than the lower limits of the desirable range thereof (biting amount: 0.3 mm and contact pressure: 0.25 N/cm²) for securing sealing effects. Therefore, leakage of toner occurs.

In comparative example 3, toner adhesion is “bad”. In comparative example 3, although toner including silicone oil and having a higher agglomeration degree is used, the biting amount and contact pressure of the lateral end seal 50 are 2.7 mm and 9.6 N/cm², respectively, which are greater than the upper limits of the desirable ranges thereof (biting amount: 2.1 mm and contact pressure: 7.5 N/cm²). It can be deemed that this causes the frictional heat between the lateral end seal 50 and the development roller 41 to increase, resulting in toner adhesion.

In comparative example 4, toner adhesion and toner leakage are judged “bad”. It can be deemed that, since the angle θ of the fiber leaning direction Z1 in comparative example 4 is 15 degrees, which is smaller than the desirable range, toner entering between the lateral end seal 50 and the development roller 41 is not returned effectively, allowing toner adhesion and toner leakage.

In comparative example 5, toner adhesion and toner leakage are judged “bad” similarly to comparative example 4. In comparative example 5, the angle θ of the fiber leaning direction Z1 is out of the desirable range. In this case, the angle θ of the fiber leaning direction Z1 is 75 degrees and greater than the desirable range. Therefore, toner is more likely to enter between fibers of the lateral end seal 50, resulting in firm adhesion of toner and leakage of toner.

By contrast, in configurations 1 through 4, all of the biting amount k, the contact pressure, and the angle θ of the fiber leaning direction Z1 of the lateral end seal 50 are within the respective desirable ranges. Consequently, this configuration can be deemed effective to prevent firm adhesion and leakage of toner.

As described above, in the present embodiment, the biting amount k of the lateral end seal 50 is within a range of from 0.3 mm to 2.1 mm, or the contact pressure of the lateral end seal 50 is within a range of from 0.25 N/cm² to 7.5 N/cm², thereby reducing the frictional heat generated between the lateral end seal 50 and the development roller 41 while securing sealing therebetween, even when toner having a higher agglomeration degree, for example, 54% or greater under the accelerated test conditions, is used. Accordingly, firm adhesion of toner between the doctor blade 43 and the development roller 41 can be inhibited. Thus, since the development device 4 according to the present embodiment can inhibit firm adhesion of toner to the doctor blade 43 or the like, creation of image failure in which vertical lines are present, can be reduced, attaining satisfactory images. Additionally, in case toner enters between the lateral end seal 50 and the development roller 41, adhesion of toner between them can be inhibited, and sealing capability of the development roller 41 and the entrance seal 48 can be maintained.

Moreover, since the lateral end seal 50 is designed such that the fiber leaning direction thereof is inclined toward the axial center of the development roller 41 as the position in the rotational direction goes downstream, toner entering between the lateral end seal 50 and the development roller 41 can be returned, preventing adhesion of toner therebetween.

Additionally, particularly in configurations in which the process unit 1 is separate from the toner cartridge 6, toner adhesion tends to be more apparent. Therefore, when applied to such configurations, the features of the present embodiment can be more effective to keep capabilities of the development roller 41, the doctor blade 43, and the lateral end seal 50 for long time.

Additionally, in so-called vertical development devices, in which the developer chamber 47 is above the development roller 41, the supply roller 42, and the doctor blade 43 as shown in FIG. 2, toner around the development roller 41 tends to coagulate, receiving a load from the toner positioned above. That is, in vertical development devices, at the positions of the development roller 41, the supply roller 42, and the doctor blade 43 that are provided in a lower section of the development housing 40, pressure of toner is higher, and possibility of toner coagulation is higher. Therefore, with the features of the present embodiment, firm adhesion of toner in vertical development devices can be inhibited effectively, thus attaining satisfactory images.

Further, possibility of firm adhesion of toner can be higher when toner having a glass transition temperature (Tg) of 40° C. or lower, which is relatively soluble, or small diameter toner is used. In these cases, application of the features of the present embodiment can effectively inhibit firm adhesion of toner.

Next, another feature of the present embodiment is described.

As shown in FIGS. 3 and 4, the entrance seal 48 is provided adjacent to the opening 40a of the development housing 40. Such entrance seals are used also in conventional configurations. In conventional configurations using the entrance seal, image failure in which vertical lines are present, or toner leakage from the entrance seal may occur due to coagulation or firm adhesion of toner between the entrance seal and the development roller.

Specifically, toner to which a lubricating component is added is susceptible to stress by driving of conveyance screws or agitators inside the development device because such toner has a higher degree of coagulation among toner particles themselves and a lower degree of fluidity. Increases in the stress on toner accelerate degradation of toner. For example, the external additive is buried in the toner particle. Then, possibility of firm adhesion of toner to the components inside the development device increases. Firm adhesion of toner can occur particularly when toner having a lower glass transition temperature (Tg) or toner of small particle diameter is used.

When toner having a higher degree of coagulation is used, toner tends to be caught in the nip between the entrance seal 48 and the development roller 41 and accumulate there. When the toner accumulation causes a flaw on the entrance seal 48, toner adhesion starts at the flaw. Consequently, wear of the entrance seal 48 is accelerated in other areas than the position of toner adhesion, and the contact pressure of the entrance seal 48 against the development roller 41 increases locally at the position of toner adhesion. Then, the development roller 41 is abraded partly by the toner adhesion, resulting in the image failure in which vertical lines are present. Moreover, toner can leak from the area where the development roller 41 is abraded.

Although, to inhibit firm adhesion of toner resulting from the frictional heat generated between the entrance seal 48 and the development roller 41, the frictional heat may be reduced by limiting the contact pressure of the entrance seal against the development roller 41 within a predetermined range, there is a need for taking consideration of agglomeration degree and fluidity of toner.

In view of the foregoing, the present embodiment is designed to inhibit the above-described firm adhesion of toner to the entrance seal 48 when toner having a higher agglomeration degree is used.

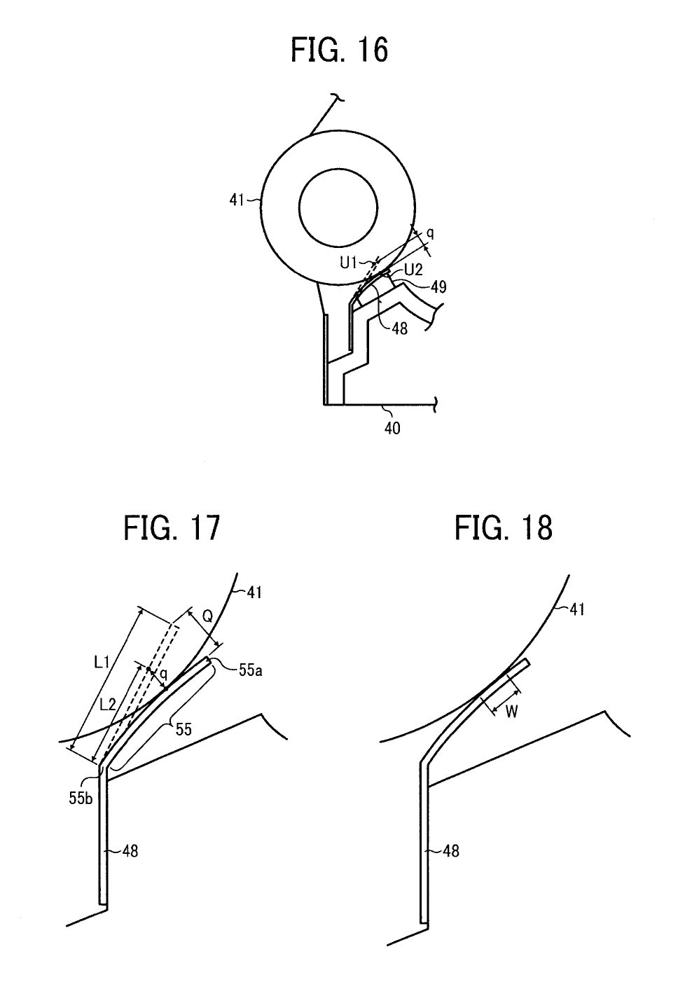

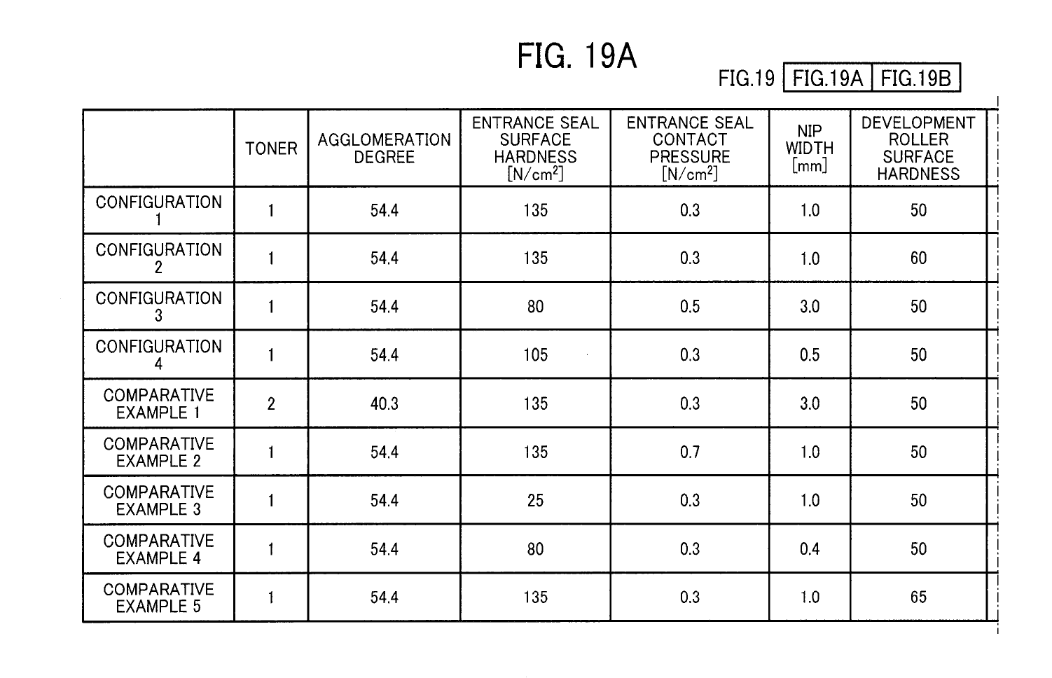

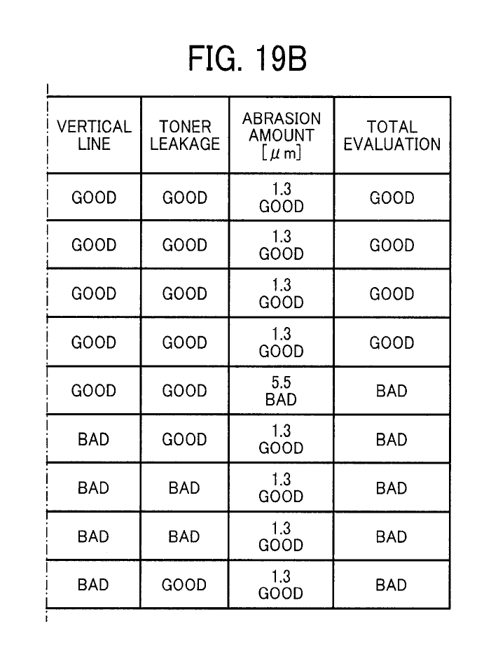

A biting amount q of the entrance seal 48 into the development roller 41 is 0.4 mm or smaller in the present embodiment. The biting amount q of the entrance seal 48 in this specification means the amount of deformation of the portion forming the nip when the entrance seal 48 is pressed against the development roller 41 with a predetermined force. Specifically, referring to FIG. 16, U1 and U2 represent a position of the entrance seal 48 that forms the nip when the entrance seal 48 does not contact the development roller 41 and when the entrance seal 48 is pressed against the development roller 41 with the predetermined force. The biting amount q can be defined as a distance between the position U1 and the position U2.

For example, in the present embodiment, the entrance seal 48 includes an arm 55 that is deformed by contact between the entrance seal 48, and an end 55a of the arm 55 contacts the development roller 41. When L1 represents a length of the arm 55, Q represents an amount by which the end 55a deforms or shifts when the end 55a contacts the development roller 41, and L2 represents a length from a base 55b of the arm 55 to the portion forming the nip (all in millimeters), the biting amount q can be expressed using the formula below.

q=Q×L2/L1 Formula 3

In the present embodiment, the biting amount q of the entrance seal 48 is limited to 0.4 mm or smaller to reduce the contact pressure between the entrance seal 48 and the development roller 41 from that in conventional configurations. Accordingly, even when toner having a higher degree of coagulation is used and adheres to the entrance seal 48, wear of the entrance seal 48 in other areas than the area to which toner adheres can be alleviated. This configuration can inhibit local increases in the contact pressure of the entrance seal 48 against the development roller 41 and accordingly reduce local wear of the development roller 41 in the area to which toner adheres, thereby inhibiting image failure. Additionally, since local wear of the development roller 41 can be reduced, leakage of toner therefrom can be inhibited.

Similar effects can be attained by reducing the contact pressure of the entrance seal 48 against the development roller 41. Specifically, it is preferred that the contact pressure (contact face pressure) of the entrance seal 48 be 0.5 N/mm² or smaller. With this configuration, local wear of the development roller 41 can be reduced, thereby reducing substandard images and leakage of toner.

Additionally, referring to FIG. 18, the nip between the entrance seal 48 and the development roller 41 preferably has a nip width W within a range of from 0.5 mm and 3.0 mm (including these values) in the circumferential direction of the development roller 41. If the nip width W is shorter than 0.5 mm, sealing effects may be insufficient. If the nip width W of the nip is longer than 3.0 mm, layout may become difficult.

Additionally, in the present embodiment, in accordance with reduction in the contact pressure of the entrance seal 48, the elastic member 49 shown in FIG. 16 is provided between the entrance seal 48 and the development housing 40 to enhance sealing therebetween. The contact pressure of the entrance seal 48 against the development roller 41 can be stabilized by the elastic member 49 supporting the second face of the entrance seal 48 opposite the development roller 41. Additionally, the elastic member 49 can reduce vibration of the entrance seal 48 during transportation of the device, securing prevention of leakage of toner from the development housing 40.

Additionally, the surface of the entrance seal 48 preferably has a Martens hardness (HMT115) of 80 N/mm² or greater. With this configuration, the entrance seal 48 is less likely to have a flaw that would be a start point of toner adhesion. Thus, firm adhesion of toner can be inhibited effectively.

Alternatively, the development roller 41 may have a lower surface hardness to reduce the contact pressure of the entrance seal 48. Specifically, the surface of the development roller 41 can have a JIS-A hardness of 60 degrees or less. With this configuration, the surface of the development roller 41 can be deformed more easily by the contact pressure of the entrance seal 48, thereby increasing the nip width W (shown in FIG. 18), that is, the circumferential length of the nip between the entrance seal 48 and the development roller 41. Consequently, the contact pressure of the entrance seal 48 decreases, thus inhibiting toner adhesion effectively. Additionally, when the surface hardness of the development roller 41 is lower, even if a small amount of toner firmly adheres to the entrance seal 48, surface unevenness caused by the toner adhesion can be absorbed in the surface of the development roller 41. Accordingly, toner adhesion is less likely to abrade the surface of the development roller 41.

Effects of the above-described setting of the contact pressure and the surface hardness of the entrance seal 48 were experimentally evaluated as follows.

FIG. 4 shows comparison results of configurations 1 through 4 according to the embodiment and comparative examples 1 through 5.

Toners 1 and 2 used in the evaluation shown in FIG. 4 are identical to toners 1 and 2 used in the evaluation shown in FIG. 8.

Conditions used in the evaluation are described below.

(Configuration 1)

Toner used in configuration 1 is toner 1 described above, which includes silicone oil. The entrance seal 48 is constructed of a commercially available polyester (PET) film, DIALAMY developed by MITSUBISHI PLASTICS, INC, having a surface hardness (Martens hardness) of 135 N/cm². The entrance seal 48 is disposed to have a contact pressure (line contact pressure) of 0.3 N/mm and a nip width of 1 mm. Additionally, the surface of the development roller 41 has a JIS-A hardness of 50 degrees.

(Configuration 2)

Configuration 2 is different from configuration 1 in that the surface hardness (JIS-A hardness) of the development roller 41 is 60 degrees.

(Configuration 3)

Configuration 3 is different from configuration 1 in that the surface hardness (Martens hardness) of the entrance seal 48 is 80 N/mm². Additionally, with the elastic member 49 provided between the entrance seal 48 and the development housing 40, the contact pressure and the nip width of the entrance seal 48 are changed to 0.5 N/mm and 3 mm, respectively.

(Configuration 4)

Configuration 4 is different from configuration 1 in that the surface hardness (Martens hardness) of the entrance seal 48 is 105 N/mm² Additionally, the width of the elastic member 49 provided between the entrance seal 48 and the development housing 40 is changed, thereby changing the nip width of the entrance seal 48 to 0.5 mm.

### Comparative Example 1

Comparative example 1 is similar to configuration 3 except that toner 2 without silicone oil is used instead of toner 1.

### Comparative Example 2

Comparative example 2 is different from configuration 1 in that the elastic member 49 provided between the entrance seal 48 and the development housing 40 is changed, thereby changing the contact pressure of the entrance seal 48 to 0.7 N/mm

### Comparative Example 3

Comparative example 3 is different from configuration 1 in that the surface hardness (Martens hardness) of the entrance seal 48 is 25 N/mm².

### Comparative Example 4

Comparative example 4 is different from configuration 1 in that the surface hardness (Martens hardness) of the entrance seal 48 is 80 N/mm², and the nip width is 0.4 mm

### Comparative Example 5

Comparative example 5 is different from configuration 1 in that the surface hardness (JIS-A hardness) of the development roller 41 is 65 degrees.

It is to be noted that the contact pressure of the entrance seal 48 in the above-described configurations and comparative examples was calculated by dividing, with the contact area, the repulsive force at the portion where the entrance seal 48 is in contact with the development roller 41.

Configurations 1 through 4 and comparative examples 1 through 5 were evaluated regarding vertical lines in images, leakage of toner, and the amount of abrasion of the photoreceptor 2 as follows.

(Evaluation of Vertical Lines in Images)

Using a multicolor printer similar to that used in the above-described evaluation, a predetermined image pattern having a printing ratio of 30% was printed consecutively on 2,000 sheets under a temperature of 27° C. and a humidity of 80%, after which a halftone image pattern was printed. Then, the number of dark vertical lines in the halftone image was counted. When there is no such line, it is judged “good”, and, when one or more lines are present, it is judged “bad”.

(Evaluation of Leakage of Toner)

A process unit of a Ricoh color printer, IPSiO SP C310 was dropped from the height of 20 cm, and eights corners thereof were faced down sequentially when the process unit wad dropped. The number of times of toner leakage after the process unit dropped was recorded. When the number of times of toner leakage is less than three, it is judged “good”, and, when the number of times is three or greater, it was judged “bad”.

(Evaluation Method of Abrasion of the Photoreceptor)

The abrasion of the photoreceptor 2 was evaluated similarly to the evaluation shown in FIG. 8.

(Total Evaluation)

Additionally, the total evaluation is deemed “good” only when all of vertical lines in images, leakage of toner, and the abrasion amount are judged “good”. When one of or both of the judgment items are “bad”, the total evaluation is “bad”.

The evaluation results are described in further detail below.

As it can be known from FIG. 4, in configurations 1 through 4, all of vertical lines in images, toner leakage, and the abrasion amount are “good”, and accordingly the total evaluation is “good”. By contrast, in comparative examples 1 through 5, one or more of the evaluation items are “bad”, and accordingly the total evaluation is “bad”.

Specifically, in comparative example 1, the abrasion amount of the photoreceptor 2 is “bad”. In comparative example 1, alleviation of surface abrasion of the photoreceptor 2 is insufficient because toner 2 without silicone oil is used. By contrast, in comparative examples 2 through 5 and configurations 1 through 4 according to the present embodiment, toner 1 that includes silicone oil is used, and the abrasion amount is “good”.

In comparative example 2, however, the evaluation of vertical lines in images is “bad”. The contact pressure of the entrance seal 48 in comparative example 2 is 0.7 N/mm², greater than the upper limit (0.5 N/mm²) of the desirable range. Accordingly, it seems vertical lines are present in output images because wear of the development roller 41 is accelerated in the where toner adheres.

In comparative example 3, vertical lines in images and toner leakage are judged “bad”. In comparative example 3, it seems that the entrance seal 48 is easily damaged by toner since the surface hardness of the entrance seal 48 is 25 N/mm², lower than the lower limit (80 N/mm²) of the desirable range. Specifically, as the entrance seal 48 is damaged by toner, toner adheres to the damaged area, thus accelerating the wear of the development roller 41 locally in that area. Accordingly, vertical lines appear in output images, and possibility of toner leakage increases.

The evaluations of vertical lines in images and toner leakage are judged “bad” also in comparative example 4. It can be deemed that the sealing capability is insufficient since the nip width is 0.4 mm and smaller than the desirable range for securing it. Regarding the vertical lines in images, it can be deemed that the reduced nip width makes the contact pressure greater than the desirable range (although the contact pressure is represented in line contact pressure in this evaluation, it exceeds 0.5 N/mm² when being converted into face contact pressure. Accordingly, wear of the development roller 41 is accelerated locally in the area to which toner adheres, creating vertical lines in output images. Moreover, the wear of the development roller 41 can be considered the cause of toner leakage.

In comparative example 5, the evaluation of vertical lines in images is “bad”. It seems that the surface unevenness created by toner adhering to the entrance seal 48 is not absorbed in the surface of the development roller 41, resulting in damage to the surface of the development roller 41, since the surface hardness of the development roller 41 is 65 degrees, greater than the upper limit (60 degrees) of the desirable range.

By contrast, in configurations 1 through 4, the surface hardness, contact pressure, and nip width of the entrance seal 48; and the surface hardness of the development roller 41 are within the respective desirable ranges. It can be deemed that, with this configuration, vertical lines in images and leakage of toner are prevented.

As described above, in the present embodiment, the contact pressure of the entrance seal 48 is 0.5 N/mm² or lower, or the biting amount of the entrance seal 48 is 0.4 mm or smaller, thereby inhibiting creation of vertical lines in images and securing the sealing capability, even when toner having a higher agglomeration degree, for example, 54% or greater under the accelerated test conditions, is used.

Specifically, even when toner having a higher degree of coagulation firmly adheres to the entrance seal 48, wear of the entrance seal 48 in other areas than the area to which toner adheres can be reduced since the contact pressure of the entrance seal 48 is low. This configuration can inhibit local increases in the contact pressure of the entrance seal 48 against the development roller 41 in the area to which toner adhere and accordingly reduce local wear of the development roller 41 in that area, thereby inhibiting image failure. Additionally, since local wear of the development roller 41 can be reduced, leakage of toner therefrom can be inhibited.

Further, possibility of firm adhesion of toner can be higher when toner having a relatively low glass transition temperature (Tg) or small diameter toner is used. In these cases, application of the features of the present embodiment can be particularly effective.

Additionally, when the nip width (length in the circumferential direction) of the entrance seal 48 is within a range of from 0.5 mm to 3.0 mm, sealing capability thereof and the flexibility in layout can be balanced.

When the surface of the entrance seal 48 has a Martens hardness of 80 N/mm² or greater, creation of flaws on the entrance seal 48, at which toner adhesion starts, can be inhibited. Thus, firm adhesion of toner can be inhibited effectively.

Additionally, when the surface of the development roller 41 has a JIS-A hardness of 60 degrees or lower, the nip width can be increased. Accordingly, the contact pressure of the entrance seal 48 decreases, thus inhibiting toner adhesion effectively. Additionally, with this configuration, even if a small amount of toner firmly adheres to the entrance seal 48, surface unevenness caused by the toner adhesion can be absorbed in the surface of the development roller 41, thus inhibiting surface abrasion of the development roller 41. Accordingly, image failure and toner leakage can be inhibited effectively.

Further, providing the elastic member 49 between the entrance seal 48 and the development housing 40 can stabilize the contact pressure of the entrance seal 48 and enhance the sealing capability. Additionally, the elastic member 49 can reduce vibration of the entrance seal 48 during transportation and the like, securing prevention of leakage of toner.

It is to be noted that, although toner to which a lubricating component such as silicone oil is added is used as the toner having a higher coagulation or agglomeration degree in the above-described evaluations of the effects of the present embodiment, similar effects can be attained in development devices that use other type of toner having a higher coagulation or agglomeration degree. Additionally, developer usable in the embodiments of the present invention can be either one-component developer consisting essentially of magnetic or nonmagnetic toner or two-component developer in which toner and carrier are mixed.

Moreover, the image forming apparatus to which the features of this disclosure are applied is not limited to the multicolor laser printer shown in FIG. 1 but may be other type printers, copiers, facsimile machines, or multifunction machines having these capabilities.

Numerous additional modifications and variations are possible in light of the above teachings. It is therefore to be understood that, within the scope of the appended claims, the disclosure of this patent specification may be practiced otherwise than as specifically described herein.

What is claimed is:

1. A development device comprising:
a developer bearer to carry developer thereon; and
a developer supply member to contact the developer bearer to supply developer to a surface of the developer bearer,
wherein the developer has a degree of agglomeration of 54% or greater, and
the developer supply member is disposed to satisfy at least one of two conditions:
a biting amount of the developer supply member relative to the developer bearer is 0.7 mm or greater; and
a contact pressure of the developer supply member against the developer bearer is 30 N/m or greater.

2. The development device according to claim 1, further comprising a voltage application unit,
wherein the voltage application unit applies voltage to at least one of the developer bearer and the developer supply member such that a potential of the developer supply member is offset by 100 V or greater to a polarity identical to a toner charge polarity relative to a potential of the developer bearer.

3. The development device according to claim 1, wherein the developer supply member comprises an elastic layer constructed of an elastic foamed material, and
a mean diameter of foam cells of the elastic layer is 250 μm or smaller.

4. The development device according to claim 1, wherein the developer supply member has a volume resistivity of 1.0×10⁶Ω or smaller.

5. The development device according to claim 1, wherein the developer comprises toner including a silica particle with silicon oil surface treatment, the silica particle externally added to a mother particle of the toner.

6. The development device according to claim 1, further comprising:
a developer container in which an supply inlet is formed to receive developer externally; and
a developer amount detector to detect an amount of developer inside the developer container.

7. An image forming apparatus comprising:
a latent image bearer on which a latent image is formed; and
the development device according to claim 1 to supply developer to the latent image.

8. A process unit removably mounted in an apparatus body of an image forming apparatus, the process unit comprising:
a latent image bearer on which a latent image is formed; and
a development device to supply developer to the latent image, the development device including a developer bearer to carry developer thereon, and a developer supply member to contact the developer bearer to supply developer to a surface of the developer bearer,
wherein the developer has a degree of agglomeration of 54% or greater, and
the developer supply member is disposed to satisfy at least one of two conditions:
a biting amount of the developer supply member against the developer bearer is 0.7 mm or greater; and
a contact pressure of the developer supply member relative to the developer bearer is 30 N/m or greater.

9. An image forming apparatus comprising:
the process unit according to claim 8; and
a transfer device to transfer an image formed by the process unit to a recording medium.
